(19) United States
(12) Patent Application Publication
(10) Pub. No.: US 2009/0158407 A1
(43) Pub. Date: Jun. 18, 2009

(54) API TRANSLATION FOR NETWORK ACCESS CONTROL (NAC) AGENT

(75) Inventors: Blair Nicodemus, North Wales, PA (US); Thomas Herchek, Blue Bell, PA (US)

Correspondence Address: WOLF GREENFIELD & SACKS, P.C., 600 ATLANTIC AVENUE, BOSTON, MA, 02210-2206, US

(73) Assignee: FIBERLINK COMMUNICATIONS CORPORATION, Blue Bell, PA (US)

(21) Appl. No.: 11/955,992

(22) Filed: Dec. 13, 2007

(51) Int. Cl. G06F 13/00; G06F 21/00

(52) U.S. Cl. 726/6; 719/328

(57) ABSTRACT

An application programming interface (API) translation agent and method for converting a message from one application configured according to a first API to a message configured according to a second API so that the first application, which is configured to communicate only in accordance with the first API, can communicate with a second application, which is configured to communicate only in accordance with the second API. The first and second applications can include a security application and a network access control (NAC) agent installed on an end point computing device, and the API translation agent can be used by the NAC agent to obtain information regarding a security status of the end point computing device, the information being used to determine whether the end point computing device is in compliance with the security policies of a network.

### TECHNICAL FIELD

Aspects and features described herein relate to a system and method for translation of an application program interface (API) for communicating with a network access control (NAC) software agent.

### BACKGROUND

The industrialized world is becoming increasingly dependent on computers and networks. While computing devices and data communications networks help make businesses and people more efficient by enabling users to obtain, process, and share information, our increasing dependency on them can also present special security challenges.

One of these challenges is ensuring the availability of computing devices and networks, and the data which is entered into, accessed from, stored on, or moved between different computing devices over the network.

Another security goal for computers and networks is ensuring the integrity of these computing devices and networks and all the details and data relating to the transaction, including the identity of the originator, the intended destination (person, process and/or computing device), date, and time of the transaction and transaction-specific information such as credit card number, item ordered, and mailing address.

Another security goal for computers and networks is ensuring confidentiality relating to computing devices and networks and the data relating to or stored on these computing devices and networks, such as online bank account balances, account numbers, login IDs, and passwords.

As described above, people and organizations frequently have a need or desire to ensure confidentiality, availability and/or integrity of computing devices, data networking devices, and/or the data stored on those devices. Unfortunately, people and organizations exist that have an explicit goal of accessing and examining confidential information, disrupting availability of computing or networking devices, performing unauthorized modifications to legitimate electronic transactions and/or electronically stored data, and/or creating illegitimate electronic transactions and/or electronically stored data. Such activities are collectively referred to as “computer attacks,” “network attacks” or simply “attacks” hereafter. An attack may target the availability, integrity and/or confidentiality of computing systems, network devices, and/or data.

One particular security attack scenario that has caused widespread concern is one where an end point becomes infected with malware at a given location and the end point is subsequently brought to a different location where the end point is then connected to the network. Once connected to the network, the infected end point could then attack or spread its malware to computing devices or networking devices directly or indirectly reachable over the network.

For this reason, individuals and organizations often install and operate computer and network security products designed specifically to protect computers, network devices or data from attackers and from attacks. Large organizations often spend considerable amounts of money to purchase commercial end point and network security products and invest considerable amounts of manpower to keep security agents and security hardware configured correctly, kept up to date, perform continuous monitoring, etc. These may be specialized hardware devices such as a firewall or secure email gateway, or alternatively may be specialized computer programs that run on general purpose operating systems such as Microsoft® DOS, Microsoft Windows®, PalmOS®, Microsoft WindowsCE®, Symbian®, Linux®, Unix®, BSD®, etc.

Security applications are typically explicitly designed by the product designer to run either on an end user's personal computing device, e.g. laptop computer, smartphone, PDA, etc. These computing devices will hereinafter collectively and generically be referred to as “end point computing devices,” “end points,” “personal computers,” or “personal computing devices.” Special purpose computer security programs designed to run on an end point computing device will hereinafter collectively and generically be referred to as “security agents” or “agents.” Security applications may alternatively be specifically designed and intended to run on a server computer accessed or used by multiple users, e.g. a mail server, web server, network print server, network file server, etc. The goal of all these security applications is to protect end point computing devices and servers from attacks.

Generally, the security agents installed on end points work as advertised and provide the expected level of protection. However, there are many situations in which a group of seemingly well-protected end points, servers and networking device, either in a standalone or interconnected mode, may not provide adequate protection. For example, a visitor or member of the organization may need to plug their personal computing device into the organization's wired or wireless network, but the visitor's computer does not have appropriate security agents installed or they are out-of-date, disabled, or misconfigured. Alternatively, a visitor or member of the organization may have accidentally or intentionally changed a configuration setting on a security agent, causing it to no longer provide certain types of protection, or may even have accidentally or intentionally removed or otherwise disables an installed security agent, causing it to no longer provide any protection. Another vulnerability can arise if a conflict between the security agent and the operating system or the security agent and another computer program installed on the end point results in the security agent not functioning completely, properly or causing it to be completely inoperable.

In all of these cases, the end point security agent does not provide the level of protection needed or expected by the organization, and the end point is therefore vulnerable to attacks or may already have been attacked. No matter how they are accomplished, such malware attacks can have considerable operational and financial consequences to an organization, including the costs to remove the malware from all impacted end points, servers and networking devices, the costs of data loss or data recovery, lost business due to unavailability of critical computers or data, disruption to normal business operations while cleanup operations are underway, etc.

For this reason, in addition to the use of security agents, there have been many different creative solutions to the problem of network protection. One approach that is rapidly becoming mainstream is a concept generically referred to in the industry as “network access control” or NAC. Note that this is also a proprietary trade name for similar security features, capabilities and products offered by Cisco Systems, Inc. under the term Network Admission Control. The term is however also generically used to refer to a security concept to be described shortly. Hereinafter, the term “network access control” or “NAC” will refer to the generic security concept whereas “Cisco Network Admission Control” or “CNAC” will refer to Cisco-specific products and capabilities.

NAC is a security concept specifically designed to protect the network and computing devices on the network from an infected or vulnerable end point. This is accomplished by essentially isolating any end point when it first connects to the network. If the end point is considered vulnerable or infected and is a potential threat to the network, it is said to be “out of compliance” or “noncompliant” or, alternatively, there is said to be a “compliance violation.” If the end point is considered safe and not a threat to begin with, it is said to be “compliant” or “in compliance” with the specified security goals of the organization and the network.

For example, before connecting to the network's resources, the end point can directly or indirectly connect to some type of networking device such as a Layer 2 Ethernet switch, Layer 3 router, wireless access point, wireless controller, wireless switch, etc., which has a capability to inspect end point data frames or packets and make a forward/filter (i.e. block) decision on the basis of that end point's current network access permissions. While the end point is so isolated, no network traffic other than data related to end point authentication, user authentication and/or inspection results can reach the end point and no network traffic from the end point can propagate onto the network. The end point thus remains isolated until an inspection of the end point has been performed, the inspection results examined and the network achieves a level of comfort that the end point poses no risk.

If malware is found on the end point or if the end point is missing an important security agent, has a misconfigured security agent, or has an out-of-date security agent, appropriate remediation actions may be necessary before the end point is permitted to transmit general traffic onto the network or receive general traffic from the network. Once the end point is remediated, where the remediation details are situation-specific, the network restriction is lifted by a network device, and the end point is granted unrestricted ability to send general data traffic onto the network or receive general data traffic from the network.

Such inspection and remediation can be accomplished by means of an “NAC solution” comprising a combination of computing devices, networking devices, data communications protocols, administration/management applications, user interfaces, directories or databases of data and/or software applications specifically designed to perform the collective activities described above or that support in some way those collective activities. These activities may be performed on separate computing or networking devices, combined onto the same computing device, or partially combined in a number of different possible combinations of integrated and standalone functionality.

An NAC solution typically includes the following logical components:

End Point: A computing device, e.g. a laptop computer, desktop computer, PDA, smartphone, server, etc. The end point might be on the same network as the NAC enforcement point, e.g. a laptop on the office LAN connected to an Ethernet switch in the nearest wiring closet or connected to a wireless access point. Alternatively, the end point may be remote from the NAC enforcement point, e.g. a user working from home or a hotel and connecting to an NAC enforcement point over an intermediate public or private network, e.g. the Internet or the PSTN.

End Point NAC Inspection Agent: A computer program that either persistently resides on the end point or is dynamically sent to the end point over the network at the time the network connection is established and inspects the end point for compliance with the network's security policies.

Enforcement Point: Network edge device that controls the end point's access rights on the network. All network traffic originating from the end point or destined for the end point flows through this point.

Authentication Server: Services authentication requests by comparing credentials presented in an authentication request to credentials stored in the user directory ad forwards end point security posture information for authenticated users to the policy server in the form of a compliance assessment request.

User Directory: A data repository containing user information such as a user ID, password, digital certificate information etc.

NAC Policy Server: Receives compliance assessment requests containing end point security posture information from the authentication server. Performs posture-to-policy comparison and determines access permissions. Returns an access control list to the authentication server.

As will be described in more detail below, the NAC inspection agent may perform different types of end point inspections, including directly querying other software programs running on the end point or receiving asynchronous notification messages from other software programs running on the end point. Hereinafter, the end point NAC inspection agent is also referred to simply as an “NAC agent.”

There are several commercially available NAC solutions utilizing NAC agents on the market. All major networking equipment vendors have embraced the concept of Network Access Control and are aggressively extending the functionality of existing network devices, including Cisco® Network Access Control (CNAC), Microsoft® Network Access Protection (NAP), and Juniper Networks® Endpoint Defense Initiative (JEDI). There are also numerous point solution vendors pushing dedicated NAC appliances, for example, Lockdown® Networks, Consentry Networks®, InfoExpress, and Vernier Networks®. Some vendors, e.g. Cisco® Systems, may offer more than one kind of NAC products, each having different feature sets. Major security-centric vendors, e.g. Symantec® and McAfee®, also offer NAC solutions.

While there are a number of NAC options available, many vendors have created a proprietary, vendor-specific method that often is not interoperable with other vendor-specific methods. This is not surprising as different vendors often produce dissimilar solutions to similar problems. If interoperability is not a specific design goal and there is no integration requirements defined during an engineering or software development project, then interoperability with other technologies and products will not occur.

There are also open-source NAC solutions under development, such as PacketFence, Rings, NetReg®, FreeNAC®, HUPnet, Ungolant. These open-source products are meant to give organizations an ability to procure a zero-cost NAC solution. If the features and capabilities do not fully address of the organization's needs, the organization has access to the source code and can create incremental code or modify existing code to tailor the feature set as needed. However, because each of these projects is independently developed, it is unlikely that there will be any interoperability among these projects or interoperability with any of the commercial, vendor-specific NAC solutions or NAC standards previously described.

To address this issue of interoperability, there are some industry-wide, standards-based NAC solutions under development. These include the Trusted Computing Group's (TCG™) Trusted Network Connect (TNC) initiative and the Internet Engineering Task Force's (IETF) Network Endpoint Assessment (NEA) initiative. These standards are meant to give network vendors, software developers and organizations a common framework, set of data communications protocols and set of standardized application programming interfaces (APIs). The intent is that if different companies design their products to a consistent set of interfaces and standards, it should be possible for different NAC components from different vendors to interoperate. However because there are two different standards, interoperability between NAC solutions still remains problematic.

In addition to these standards, other standards in the networking world provide extensibility features that allow different vendors and different user organizations to add additional features on top of the standard. These proprietary extensions require additional custom software to be written to support the transmission or receipt of the additional features. It is also important to note that even though standards may exist, vendors may continue to offer, promote and indeed extend their own proprietary offering if the standard does not meet the vendor's needs.

Application programming interfaces (APIs) are commonly used in software development, including the development of software for security agents used with NAC solutions. An API is a defined messaging interface into and/or out of a software component to provide an interface through which two software components can communicate. Depending on how the API is implemented, multiple applications may simultaneously be able to use or communicate with the same API. However, the communication capabilities supported (e.g. the types of information that can be forwarded or received) as well as the mechanical details of how the communications occur (e.g. what language is used, the structure of messages, command syntax, how to reference data objects, programming language used, etc.) still can be defined by the author of that software component.

Applying this concept to NAC agents, the designer and/or vendor of each NAC product or standard that includes an NAC agent as part of its solution can determine whether or not an API for the purpose of inspecting other applications configurations and/or status (hereinafter an “inspection API”) is offered. The NAC agent designer/vendor also can determine the programming language used, the services offered by the API, the services required by the API, and the minute structured details of each message supported across the API's messaging interface. In addition, the details of these APIs can vary widely across available NAC solutions.

Given that there are numerous NAC solutions available and anticipated to become available over the next few years, it is difficult and costly for a software development organization to support each available NAC solution, NAC agent, and particular NAC API. For example, as standards and vendor-specific solutions evolve, the API capabilities and design details are highly likely to evolve as well, requiring renewed, repeated integration efforts to support the new NAC agent API version 2, version 3, version 4, etc., which can require significant labor costs, overhead costs, and opportunity costs.

Given these costs, a developer or organization that author and maintain a given application must decide how many NAC solutions, NAC agents and NAC agent APIs they will support, and if less than 100% of the solutions available today and in the future, which ones will be supported, when will that support be added, and in what order (i.e. relatively priorities of each NAC agent API). Most application developers and organizations are likely to only invest time, effort and money to support a very small number of NAC agent APIs. This creates a “solutions gap” when there is demand for a specific application (and by implication the owning developer and/or organization) to support a new, additional API not currently supported. No matter how legitimate the needs of one customer or application user, the direct costs, indirect costs, and opportunity costs of writing code to that additional API will weigh down on the developer and development organization and continue to create a constraint around which NAC agent APIs to support and integrate with.

Ideally, a developer or development organization could write an application according to one API that could interface with any application or equipment regardless of the API.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

Embodiments in accordance with aspects and features described herein provide methods and systems for a Network Access Control Application Programming Interface Translation Agent (hereinafter referred to as an “NAC API Translation Agent”). An NAC API Translation Agent can translate messages written for one NAC agent API into a format suitable for use with a different NAC agent API. Multiple NAC agent APIs can be thus supported, and multiple NAC agent APIs can be used simultaneously.

One benefit of an NAC API Translation Agent in accordance with aspects and features described herein is that it can decouple a software application that needs to support a particular NAC agent API from that NAC agent, and enable it to be used for any NAC agent. This makes it possible for organizations that use NAC solutions and that want to develop or use NAC-integration-capable software applications to select and use the NAC agent of their choice without affecting the software application. Conversely, it makes it possible for organizations to select and use the software application of their choice, knowing that via the NAC API Translation Agent they can use the software application with any NAC solution, NAC agent and NAC agent API.

One embodiment of an NAC API Translation Agent in accordance with one or more aspects described herein can act as a translator for a software application that has been integrated with one specific NAC agent API and thus supports a specific NAC agent API to permit it to communicate with a different NAC agent API that is not directly supported by the application. Another embodiment of an NAC API Translation Agent in accordance with one or more aspects described herein can simultaneously support two or more software applications that each support a different NAC agent API and allow the applications to support an altogether different NAC agent API that neither software applications natively supports. Other embodiments of an NAC API Translation Agent in accordance with one or more aspects described herein can be used in cases where an organization upgrades their NAC solution and NAC agent to a new version or replaces their NAC solution vendor, and can allow existing applications that do not natively support the new NAC agent version or vendor to communicate with such newer or different NAC agent vendors or versions. Additional embodiments of an NAC API Translation Agent in accordance with aspects herein can be used in cases where an organization upgrades or replaces a software application from one that supports the API used by the organization's NAC solution to one that does not, and can allow such new software applications to communicate with the existing NAC agent without having to replace the NAC agent or its associated NAC equipment. Still other embodiments can be used in the case where an organization uses many different software applications on the end point computing device, some of which support the desired NAC agent API, and some of which do not, and an NAC API Translation Agent in accordance with one or more aspects herein can be used for those software applications that do not support the desired NAC agent API so that they can operate alongside those applications that do support the desired NAC agent API.

Thus, an NAC API Translation Agent in accordance with one or more aspects and features described herein can enable organizations to choose the combination of NAC agents and software solutions that best suit their needs. In addition, organizations can upgrade or change the equipment used for their NAC solutions and upgrade or change the associated NAC agent without having to make corresponding changes to other software that might wish to communicate with the organization's network. Moreover, developers of software solutions will not have to write separate software methods to address each NAC agent's API but can write one software method and be able to interface with any NAC agent, thus enabling software vendors to offer more streamlined software at a lower cost.

### BRIEF DESCRIPTION OF THE DRAWINGS

FIG. 1 is a block drawing of an exemplary network configuration in which an NAC solution in accordance with one or more aspects and features described herein might be used.

FIG. 2 is a block drawing depicting exemplary logical components of an NAC agent in accordance with one or more aspects and features described herein.

FIG. 3 is a block diagram depicting an exemplary end point inspection logical component communicating with various software applications on an end point computing device.

FIG. 4 is a block diagram depicting exemplary logical components of an NAC API Translation Agent in accordance with one or more aspects and features described herein.

FIG. 5 is a block diagram depicting one exemplary embodiment of use of an NAC API Translation Agent in accordance with one or more aspects and features described herein.

FIG. 6 is a block diagram depicting another exemplary embodiment of use of an NAC API Translation Agent in accordance with one or more aspects and features described herein.

FIG. 7 is a block diagram depicting another exemplary embodiment of use of an NAC API Translation Agent in accordance with one or more aspects and features described herein.

FIG. 8 is a block diagram depicting another exemplary embodiment of use of an NAC API Translation Agent in accordance with one or more aspects and features described herein.

FIG. 9 is a block diagram depicting components of an exemplary NAC API Translation Agent in accordance with one or more aspects and features described herein.

FIG. 10A depicts an exemplary NAC Inspection Interface software module of an NAC API Translation Agent in accordance with one or more aspects and features described herein. FIG. 10B depicts an exemplary NAC interface Emulator software module of an NAC API Translation Agent in accordance with one or more aspects described herein.

FIG. 11 depicts an exemplary configuration of a Protocol Translation and Routing Module and interfaces with other modules in an NAC API Translation Agent in accordance with one or more aspects and features described herein.

FIG. 12 depicts an information flow in an exemplary posture validation request from a Cisco® Trust Agent Posture Agent to a TNC compliant NAC Integrity Measurement Collector and its ensuing response.

FIG. 13 depicts an information flow in an exemplary high level posture change notification sequence that can be used by an application to alert the NAC agent there is a change in posture of the end point.

### DETAILED DESCRIPTION

The aspects summarized above can be embodied in various forms. The following description shows, by way of illustration, combinations and configurations in which the aspects can be practiced. It is understood that the described aspects and/or embodiments are merely examples. It is also understood that one skilled in the art may utilize other aspects and/or embodiments or make structural and functional modifications without departing from the scope of the present disclosure.

In particular, aspects and features of an NAC API Translation Agent may at times be described herein in the context of particular NAC solutions or NAC equipment vendors such as those provided by Cisco Systems, Inc., Juniper Networks, or Microsoft®, or in the context of particular software applications such as Symantec Norton Antivirus®, Symantec Endpoint Protection®, McAfee VirusScan®, Trend Micro AntiVirus®, but it should be noted that these particular solutions, vendors, and applications are merely exemplary, and that aspects and features described herein can be applied equally as well to other solutions, vendors, and applications.

In addition, although aspects of an API Translation Agent are described herein in the context of Network Access Security, network security equipment and security applications on a network or on an end point computing device, API translation methods and systems described herein can be equally applicable to any procedures used by a network to check an end point computing device for compliance with network policies or configurations. For example, if an enterprise uses Cisco equipment for its authentication or policy servers, an API translation method and system in accordance with aspects described herein can be used to allow the network equipment to interface with any software residing on the end point computing device to check whether the device has the proper software or proper versions of software loaded and ready so that the device is compatible with the requirements of the network.

As previously described, people and organizations frequently have desire to ensure confidentiality, availability and/or integrity of computing devices, data networking devices, and/or the data stored on those devices.

Network Access Control (NAC) is a security concept specifically designed to provide these types of protection. A “NAC solution” can include computing devices, networking devices, data communications protocols, administration/management applications, user interfaces, user directories, data repositories, and/or software applications specifically designed to work to protect a network and/or computing devices from security vulnerabilities.

For example, when an end point first connects to the network, the end point can directly or indirectly connect to a networking device such as a Layer 2 Ethernet switch, Layer 3 router, 802.11 access point, or wireless switch which inspects end point data frames or packets and makes a forward/filter (i.e. block) decision on the basis of that end point's current network access permissions. Initially the end point is isolated, such that the end point is unable to transmit or receive any network traffic other than data specifically related to end point device authentication, user authentication and/or end point inspection results. The end point thus remains isolated until an inspection of the end point has been performed, the inspection results examined and the network achieves a level of comfort that the end point poses no risk. At this point, a series of commands can be sent to various network devices that cause the end point to have more liberal and possibly unrestricted network access privileges.

An NAC solution must collect end point security status information in order to determine whether the end point is in compliance or out of compliance with organizational security policies. Focal points for end point inspections performed by an NAC agent can include the operating system running on the computing device and security agents running on the computing device.

Different NAC solutions offer different capabilities, have different limitations, and have different purchasing, installation and ongoing support costs. Different solutions may be more or less optimal for different user groups and network.

The following is a high level description of the logical components typically included in an NAC solution:

End Point: A computing device, e.g. a laptop computer, desktop computer, PDA, smartphone, server, etc. whose security status is in question and must be assessed.

End Point NAC Inspection Agent or “NAC Agent”: A computer program that can either persistently reside on the end point or be dynamically sent to the end point over the network at the time the network connection is established. Can directly inspect the end point and/or query other applications (via an API) residing on the end point to collect a specified list of end point security parameters (collectively known as the end point security state or security posture). An NAC Agent also can create an aggregated list of security parameters and their current values (hereinafter “inspection results”) and forward the aggregated inspection results to the enforcement point in a separate security status message or as additional data attributes appended to a different type of message, e.g. authentication. Inspection results reported by the NAC Agent can be presented to the enforcement point so that the network can determine appropriate network access privileges.

Enforcement Point: A network edge device to which the end point is directly or indirectly connected. The enforcement point receives inspection results from an end point and forwards them to an appropriate device (e.g. authentication server or assessment server). The device returns an access control list (ACL) of some type (e.g. VLAN, SSID, MAC Address filtering, IP address filtering, etc.) to the enforcement point. The device applies the ACL which then controls the end point's network access privileges, permitting, restricting or totally blocking traffic to and from a particular end point based on its current end point state.

Authentication Server: Services authentication requests by comparing credentials presented in an authentication request to credentials stored in the user directory. The authentication server can relay end point inspection results between an enforcement point and an assessment or policy server.

User Directory: A data repository containing user information such as full name, user ID, password, department, organization role(s), and/or policy information (e.g. policy group(s), required antivirus program, required firewall vendor and version, etc.).

NAC Policy Server: Receives inspection results (e.g. from enforcement point or authentication server). Compares inspection results to required end point status and determines network privileges. Generates an ACL which is transmitted to an enforcement point or authentication server.

In accordance with one or more aspects described herein, and NAC agent can directly inspect the end point to collect security state information. Direct inspections are typically queries directed at the operating system about installed applications, running applications, and the operating system itself, for example, determining whether a specific process is resident in memory, searching the file system for the presence of specific folders/directories and/or files, or searching for the presence of a configuration setting on the end point.

Alternatively, an NAC agent can inspect specific applications running on the end point through the use of an Application Programming Interface (API). An API is a defined messaging interface that initiates and/or receives requests, initiates and/or receives notifications and/or initiates and/or receives status messages to/from specific applications running on the end point.

An NAC agent API may simultaneously support communications with one or more applications running on the end point. Note that communication capabilities (e.g. the services offered and the types of information that can be provided or received) as well as the mechanical details of how the communications occur (e.g. what programming language is used, the structure of messages, command syntax, how to reference data objects, etc.) are completely defined by the API designer. One skilled in the art can appreciate that there can be many differences among the different APIs that work with different NAC agents. In fact, there are currently many types of available NAC solutions available today; each having a different API. If an application does not support that API, communication with the NAC agent via the API is not possible.

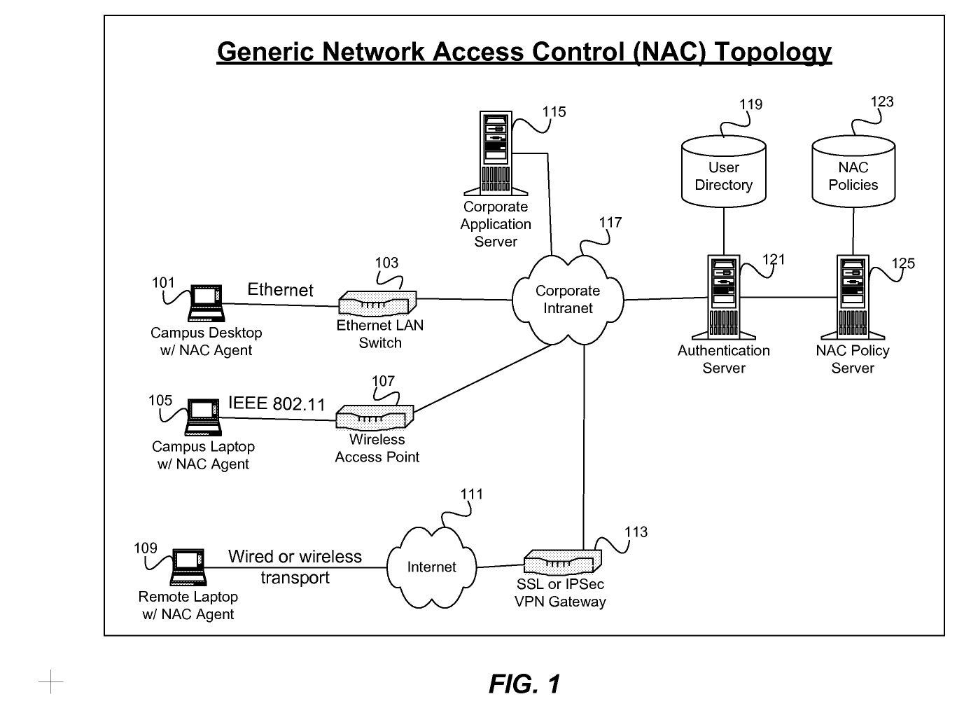

An exemplary configuration of a network NAC solution is shown in FIG. 1. As noted above, an NAC solution can include a combination of computing devices, networking devices, data communications protocols, administration/management applications, user interfaces, directories or databases of data and/or software applications that can protect the network from malware or other attacks.

As shown in FIG. 1, a network NAC solution can include a corporate intranet 117 which is used to distribute computing resources from a corporate application server 115 and which is connected to an authentication server 121 and an NAC policy server 125. The network can be configured to work with one or more end point computing devices 101, 105, and 109 that connect to corporate intranet 117 via varying connection means. For example, a network can include an on-premises desktop computer 101 that connects to intranet 117 via an Ethernet LAN switch 103 or an on-premises laptop computer 105 that connects to intranet 117 via an IEEE 802.11 wireless access point 107. The network also can include one or more remote users, such as remote laptop 109 that seeks to connect to the corporate intranet 117 by way of a wired or wireless connection to the internet 111 and an SSL or IPSec VPN gateway 113. In each of these cases, the end point device can have an NAC agent, described in more detail below, residing thereon, which can be used to inspect the end point device to determine whether it complies with the organization's security policies before the device is permitted access to the network.

Using the network solution elements shown in FIG. 1 as exemplary, an NAC solution used by an organization can provide network access control in the following manner.

The NAC agent, for example, residing on campus desktop computer 101, can inspect the end point for specific conditions at time of authentication. Depending on implementation details, the NAC agent may also inspect the end point periodically for the remainder of the network connection. The NAC agent can marshal and aggregate the end point inspection results and transmit them to the network connectivity device, for example, Ethernet LAN switch 103. Authentication credentials may accompany or immediately precede the end point inspection results, depending on implementation details. Ethernet LAN switch 103 can then forward the inspection results (and if applicable the authentication credentials) to authentication server 121. This may occur as part of an authentication transaction and/or may occur some time subsequent to an authentication transaction.

Authentication server 121 can authenticate the user of campus desktop computer 101 by comparing the presented authentication with credentials stored in an authentication database or user directory 119. If the inspection results are associated with an end point that has already been authenticated, this step may be skipped.

If the user or end point successfully authenticates, authentication server 121 can send a request containing the end point inspection results to the NAC policy server 125 so that compliance assessment of desktop computer 101 can be performed. NAC policy server 125 can compare the just received end point inspection results with administratively defined end point policies stored in an NAC policy database 123 for that particular user, that particular end point or the particular group or role that the user or end point belongs to. This comparison process is commonly referred to as a “compliance assessment.”

Depending on whether or not end point is compliant and the particular compliance exceptions or violations that may exist, the NAC policy server 125 can create an access control list (ACL) appropriate for that end point and that end point's current compliance status. NAC policy server 125 can then return a compliance status response message and the ACL to authentication server 121, and authentication server 121 can return an authentication status response message and the ACL to the network connectivity device, e.g., Ethernet LAN switch 103. Ethernet LAN switch 103 can then send a status message to desktop 101 and applies the ACL using a traffic filtering process.

In accordance with aspects described herein, desktop 101 can receive a status message indicating whether or not network connectivity has been granted. The end point may also receive a status message indicating whether or not any compliance violations were detected, indicating whether or not any network access restrictions are currently being applied, indicating whether or not any remediation is required, indicating what remediation steps the user must perform and/or indicating that full network access has been granted.

Desktop 101 may also display a status message to a user, automatically initialize a software application (e.g. a web browser), start to transmit data to accessible servers on the network, and/or transition to an idle-but-connected state and wait for user commands. Desktop 101 and the end user of desktop 101 now have authorization to utilize computing resources from corporate application server 115 across the network 117, for example, email, documents, or other resources.

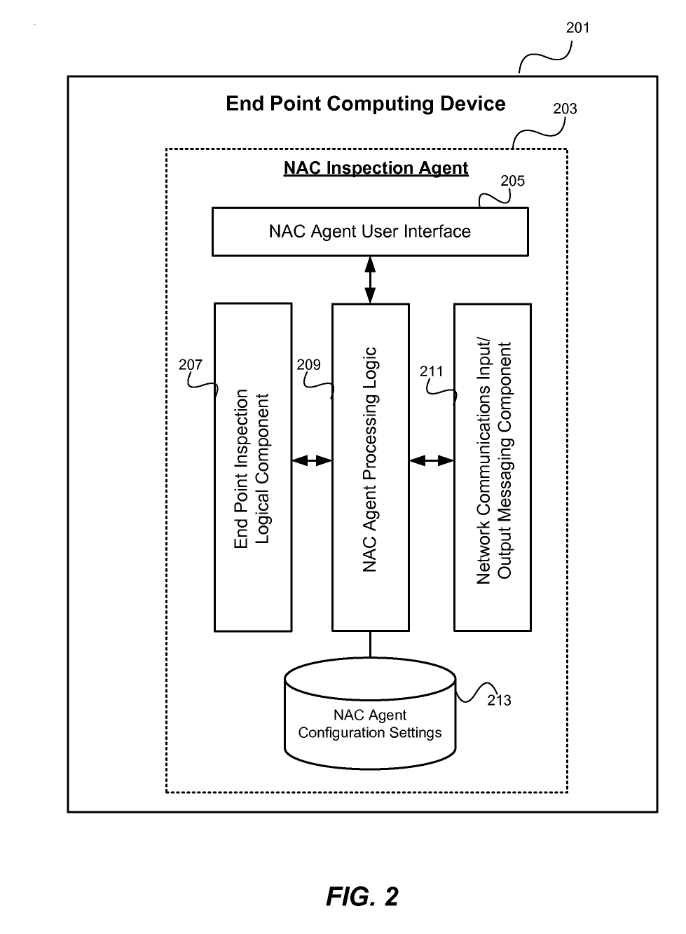

As described above, an NAC agent can be a software application that either resides on the end point device or that is dynamically sent to the end point over the network at the time the network connection is established and inspects the end point for compliance with the network's security policies. A logical configuration of an exemplary NAC agent on an end point computing device is shown in FIG. 2.

As shown in FIG. 2, an NAC Inspection Agent 203 residing on an end point computing device 201 can include an NAC agent user interface 205, an end point inspection logical component 207, an NAC agent processing logic 209 using NAC agent configuration settings 213, and network communications input/output messaging component 211. These logical components can communicate with one another via conventional inter-process communications methods.

As noted above, end point inspection logical component 207 can collect information regarding end point security parameters from end point computing device 201 via an API. It should be noted that the particular collection method utilized by any specific NAC agent can vary depending on how the software for the NAC agent it written, and thus may be vendor-specific or application-specific.

NAC agent processing logic 209 is the core logical component of the NAC agent. It is responsible for executing business logic and for controlling all processing and communication activities performed by the NAC agent, including managing all end point inspections and API message exchanges via the NAC agent end point inspection logical component. Processing logic 209 can also direct inspection component 207 to inspect end point computing device 201 via the API on the basis of an elapsed time interval, a directive received from a network device, in response to a system event or in response to a message received via an inspection component API. Combinations of these triggering events are also possible.

Processing logic 209 can also manage communications with the network via NAC agent network communications input/output messaging component 211. Processing logic 209 can proactively communicate status information or end point inspection results to the network device, can communicate the same in direct response to a directive or request from the network device, can receive configuration settings from the network device and reconfigure itself accordingly, and/or receive configuration settings and persist them to a local configuration settings data repository.

NAC agent network communications input/output messaging component 211, sometimes called simply “NAC agent network interface.” This component of an NAC agent in an end point computing device can receive commands, software updates and/or status messages from one or more network devices; transmit end point inspection results, status messages and/or security alerts to one or more network devices, and communicate with NAC agent processing logic 209 via an inter-process communications method. Various methods for communicating with network devices exist in the art and are not described herein.

NAC agent configuration settings 213 include data values, rules, etc. that the NAC agent uses to drive certain behaviors. There could be any number of configuration values, and the values may be mandatory or optional, single value or multi-value. Examples of configuration settings that an NAC agent may use include IP address of a remote server the NAC agent needs to send information to; inspection interval, i.e., interval in minutes or seconds between period inspections the end point security parameters; text of status messages to display to a user of the end point computing device in certain situations; and list of applications or security agents to be detecting during polling of the end point computing device. These or other configuration settings used by the NAC agent can be transmitted to the NAC agent during routine communications with a network device, may be included as part of the NAC agent installation package, or a combination of those two approaches.

NAC agent User Interface (UI) component 205 is a logical component that may or may not be part of an NAC agent, depending on the NAC solution used. The UI component provides a method by which the NAC agent can display status information to the user of the end point computing device. For example, it may be necessary to inform a user of situations such as need for or initiation of an end point inspection, discovery of one or more security or compliance issues during inspection, or the need for remediation activities in order for the user and the end point computing device to obtain unrestricted network access. The nature of information displayed on NAC agent UI 205 can vary depending on the NAC solution used.

UI component 205 can also provide one or more user controls that an end user can use to control or influence the NAC agent's behavior and functionality. For example, the NAC agent may provide user controls that allow a user to open or close the UI, manually initiate an end point inspection or manually initiate one or more remediation activities. As with the type of information displayed, the user controls provided on NAC agent UI 205 can vary depending on the NAC solution used.

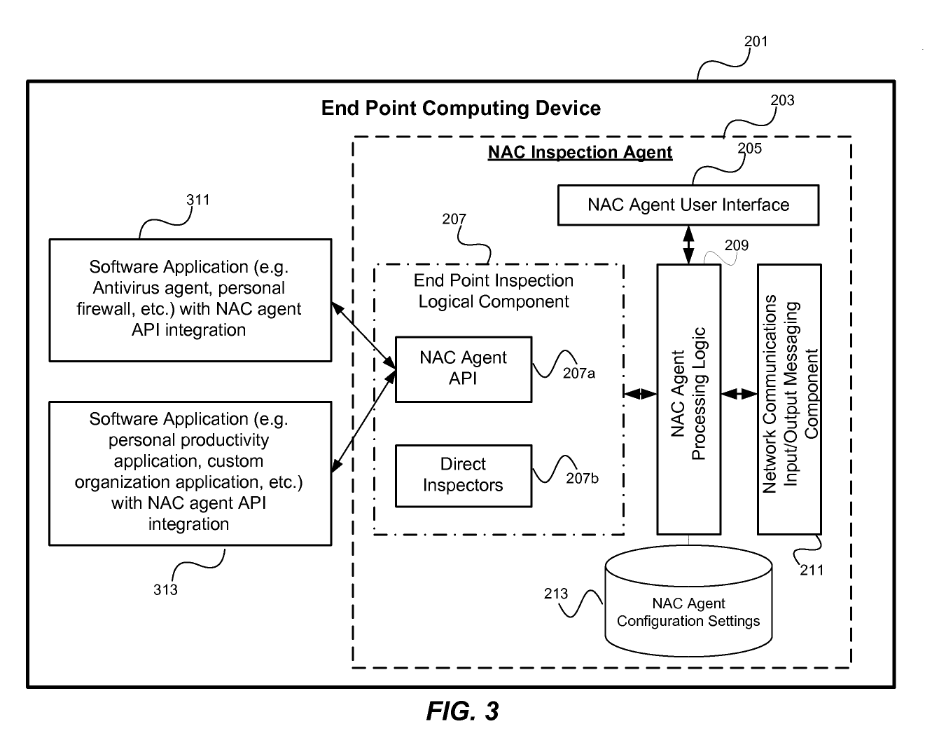

FIG. 3 depicts an example of how end point inspection logical component 207 can communicate with various software applications installed and running on the end point computing device.

As shown in FIG. 3, one or more software application such as an antivirus or firewall application 311 or other application 313 can communicate with the end point inspection logical component 207 of NAC inspection agent 203. As noted above, these communications can be by way of direct inspectors 207b, or instead, as shown in FIG. 3, by way of an NAC Agent API 207a. In the configuration shown in FIG. 3, both software applications 311 and 313 are integrated with the API used by the NAC agent, but as discussed in more detail below, it is also quite possible that one or more of software applications 311 and 313 is not so integrated, and instead uses a different API.

The remaining components shown in FIG. 3 are the same as those described with respect to FIG. 2, i.e., NAC Agent 203 residing on end point computing device 201 and having logical components NAC agent processing logic 209, network communications component 211, NAC agent configuration settings 213, and NAC agent user interface 205.

As described above, an API is a messaging interface authored and designed to allow one software component (component A) to communicate with other software components (B, C, D, etc.). Once software component A's API is designed, it is these other software components (B, C, D, etc.) that must be explicitly modified, extended or enhanced in order to be able to support component A's API and thereby be able to receive and pass messages to/from component A via the API.

An NAC-specific example will illustrate this point. Cisco Systems, Inc. (hereinafter “Cisco”) has an NAC solution (“Cisco® NAC” or “CNAC”) that includes an NAC agent product called the Cisco® Trust Agent (“Cisco® CTA” or “CTA”). The CTA has an API that provides a messaging interface to communicate with other applications, e.g. a security agent such as an antivirus security agent. Symantec®, Trend Micro®, and McAfee® are examples of vendors with commercially available and widely used antivirus security agents. If these or other antivirus vendors, security application vendors, vendors of other types of applications, or organizations with applications they developed or use internally want to have the ability to pass application configuration, current status, and historical event information to the CTA via the CTA API, they must design, code, test and verify software code written expressly for this purpose, and written exactly as specified and documented in the NAC agent API design specification.

When NAC agent API integration does not exist, it creates a potential security vulnerability even when an NAC solution and NAC agent are deployed. This is because in the absence of NAC agent integration, there is a limited amount of information the NAC agent can collect about the application. It is entirely possible that a security vulnerability exists on the end point or indeed the end point is already compromised, yet because there is no API integration with the NAC agent, the NAC agent is unable to collect information that would expose this security risk.

A similar risk exists if the organization selects NAC solution X, resulting in NAC agent X and NAC agent API X, and a particular application only supports NAC solution Y, NAC agent Y and NAC agent API Y. Even if the particular application supports NAC agent and NAC agent API Y and W, the fact that it does not support NAC agent API X and the corresponding NAC solution used or desired to be used by the organization creates a security risk.

While NAC agent API support and existing API integrations can be one evaluation criterion for choosing a particular NAC solution, an organization should not have to choose a suboptimal NAC solution just because that particular NAC agent has already been integrated with the applications of interest to the organization. Conversely, an organization that has selected the NAC solution that best meets their needs should not have to still be exposed to security risks because the organization has applications that are not integrated with the NAC agent. Ideally an end user organization should be able to pick any application and have it easily integrate with any NAC agent, regardless of the API differences among NAC agents.

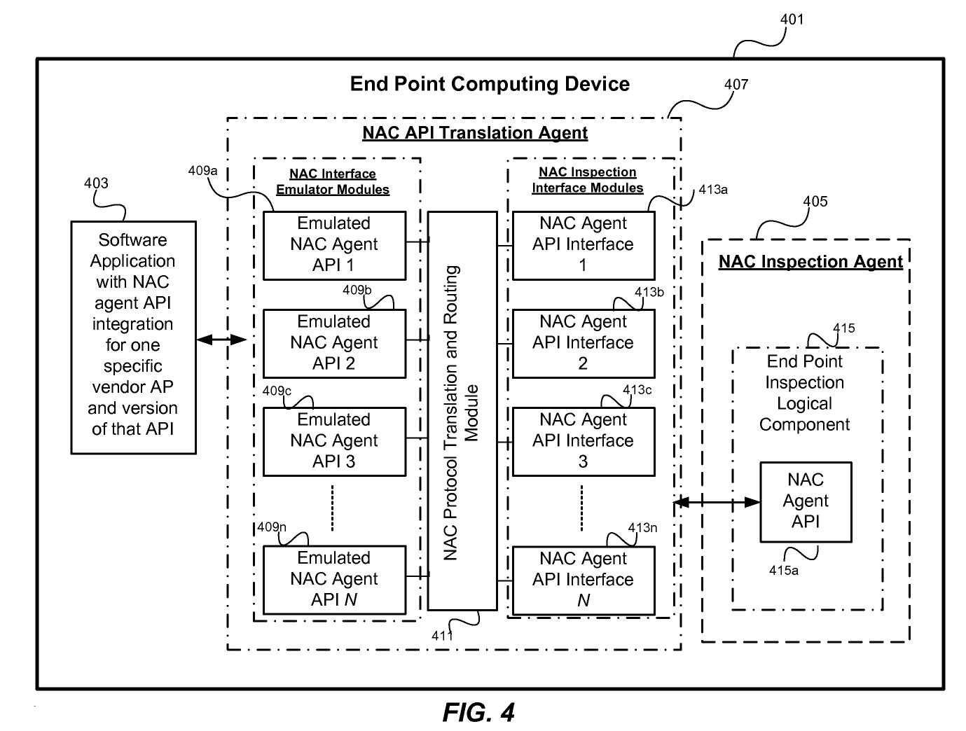

An NAC API Translation Agent in accordance with aspects described herein can resolve many of these problems of integrating NAC solutions with NAC agents and software applications. As shown in FIG. 4, embodiments of an NAC API Translation Agent 407 in accordance with one or more aspects or features described herein can have three major logical components.

A first logical component comprises a set of multiple NAC API Translation Agent NAC API software modules or functionality “blades” 409a, 409b, 409c . . . 409n. Each software module or blade is a clone, replica or emulation of a single, specific NAC agent API, including vendor specific versions (Cisco, Juniper, Microsoft, etc.), vendor-version versions (CTA v1.0, CTA v2.0, CTA v3.0, etc.), standards-based APIs (IETF NEA, TCG™ TNC, etc.) or open-source NAC agent APIs (FreeNAC®, NetReg®, etc.). Each software blade can emulate a specific NAC agent API and can be a vehicle through which software application 403 reports end point inspection results and receives end point inspection commands. When software application 403 is communicating with one of software modules 409a . . . 409n, the software application 403 believes it is communicating directly with the actual NAC agent 405. A blade 409a . . . 409n and the NAC API Translation Agent 407 can thus service or provide services via an API to a software application 403 by emulating an NAC Inspection Agent 407 and in particular by emulating an NAC Inspection agent API 415a.

A second component is NAC protocol translation and routing business logic 411. This logical component can consist of custom software code and configuration rules necessary to know which blades 409a . . . 409n to use to communicate with software applications 403 (by emulating an NAC Inspection agent 405) and which blades 413a . . . 413n can use to communicate with an actual NAC Inspection agent 405 by emulating a software application 403 and perform the necessary message translations.

A third logical component is an NAC API Translation Agent NAC API Client, which comprises a series of software modules or functionality “blades” 413a, 413b, 413c . . . 413n. Each software module or blade can be written to fully support a specific NAC agent API 415a, including vendor specific versions (Cisco, Juniper, Microsoft, etc.), vendor-version versions (CTA v1.0, CTA v2.0, CTA v3.0, etc.), standards based APIs (IETF NEA, TCG™ TNC, etc.) or open source NAC agent APIs (FreeNAC®, NetReg®, etc.). Each software blade 413a, 413b, 413c . . . 413n can communicate end point inspection results from software applications 403 and can support bidirectional status messages and notifications in accordance with the design requirements of a specific NAC agent API 415a and NAC inspection agent 405. Each software blade 413a, 413b, 413c . . . 413n also can communicate directly to the actual NAC Inspection agent 405 using the real NAC agent's API 415a. In accordance with one or more aspects described herein, when NAC API Translation Agent 407 communicates with NAC Inspection agent 405 via NAC agent API 415a, NAC Inspection agent 405 believes it is communicating directly with the actual software application 403.

This capability of the NAC API Translation Agent has considerable value in that it effectively “decouples” the NAC Inspection Agent API support built into the software application (in which the software application only supports NAC Agent API X) from the NAC Inspection Agent API support built into the NAC Inspection Agent (which only supports NAC agent API Y). This decoupling provides freedom of software application selection without concern for what NAC Agent API(s) the software application supports or what NAC Agent API exists in the preferred NAC solution and NAC agent. This decoupling further provides freedom of NAC solution and NAC agent selection without concern for what NAC agent API is supported by the preferred software applications. By eliminating this interoperability constraint, software applications and NAC solutions/NAC agents can be independently evaluated and selected based on their other capabilities and merits, knowing that connectivity between the preferred software application(s) and the preferred NAC solution/NAC agent can easily be achieved by leveraging the capabilities of the NAC API Translation Agent.

Some exemplary practical embodiments of an NAC API Translation Agent in accordance with aspects and features described herein are discussed below.

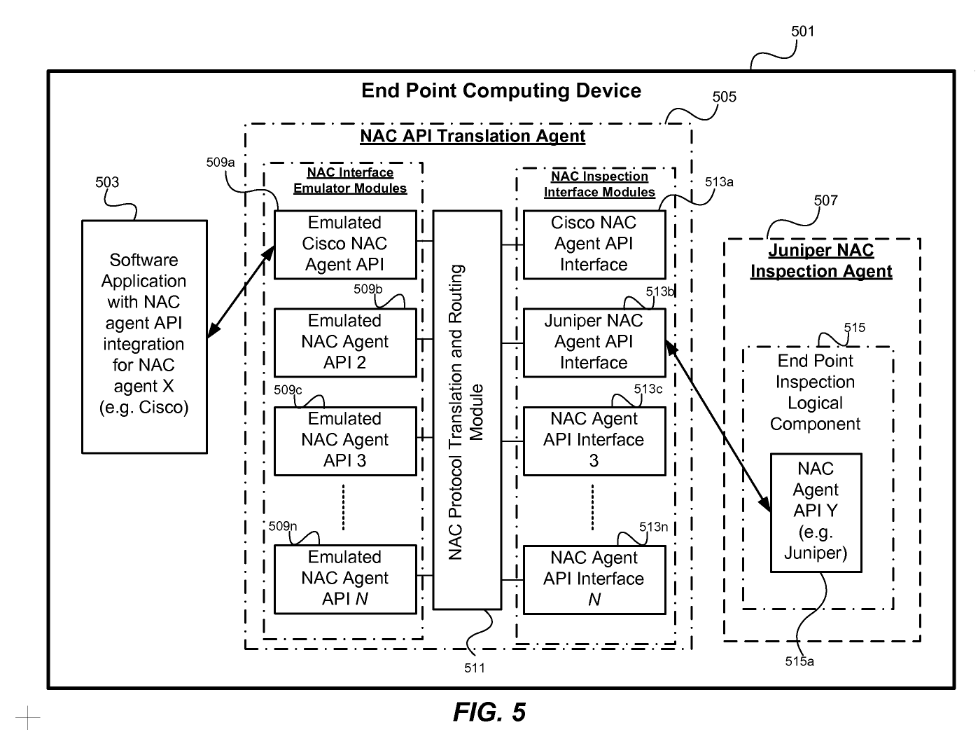

One exemplary embodiment of an NAC API Translation Agent in accordance with aspects and features described herein is shown in FIG. 5. As shown in FIG. 5, an NAC API Translation Agent 505 can act as a translator or interpreter between a software application 503 which has been integrated with one NAC agent's API and a different, unsupported NAC Inspection Agent 507 having an NAC agent API 515a that is not supported by the software application 503.

As shown in FIG. 5, a selected software application 503 currently only has support for one particular NAC agent API, for example, the Cisco® Trust Agent API. However, in the example, the organization uses the Juniper Networks NAC solution, meaning the Juniper NAC agent must be used on the end point computing device 501, and that the Juniper NAC agent 507 and the Juniper NAC Agent API 515a, not the Cisco® Trust Agent and the Cisco® Trust Agent API, is available on the end point computing device 501 for use by a software application 503. The Juniper® NAC agent currently supports the Trusted Computing Group (TCG™) Trusted Network Connect (TNC) Integrity Measurement Collector (IMC) Interface (IF-IMC). Therefore for the purpose of this example, the “Juniper® NAC agent API” and the “TCG™ TNC IF-IMC API” are equivalent.

In accordance with aspects described in more detail below, an NAC API Translation Agent 505 can emulate a specific NAC agent API to permit a software application 503 to interface with the NAC Agent API used on the end point computing device 501. For example, in the exemplary embodiment shown in FIG. 5, NAC API Translation Agent 505 can emulate the Cisco Trust Agent API 509a, which can enable software application 503 to communicate end point inspection results using Cisco® Trust Agent API 509a it was designed to support. In addition, NAC API Translation Agent 505 also can support other NAC agent APIs, for example, the Juniper NAC agent API 515a. NAC API Translation Agent 505 can act as an intermediary between software application 503 supporting the Cisco® NAC Agent API and a Juniper® NAC Inspection Agent 507 having End Point Inspection Logical Component 515 which uses the Juniper® NAC agent API 515a. A component of NAC API Translation Agent 505 is NAC Protocol Translation and Routing Module 511 which can translate and route messages passed between the software application 503 and any NAC Inspection Agent, e.g. Juniper® NAC Inspection Agent 507, so that, for example, the results of an end point inspection reported by software application 503 using message types and message syntaxes defined by Cisco Systems, Inc. and used by a Cisco® Trust Agent API can be passed to End Point Inspection Logical Component 515 in Juniper® NAC Inspection Agent 507 using message types and message syntaxes defined by Juniper Networks® and used by the Juniper® NAC Agent API 515a.

This capability can allow an organization to select the best software application for its needs regardless of which NAC agent API the software application supports. This capability also can allow an organization to select the best NAC solution and NAC agent for its needs regardless of whether or not all existing software applications support that particular NAC agent's API.

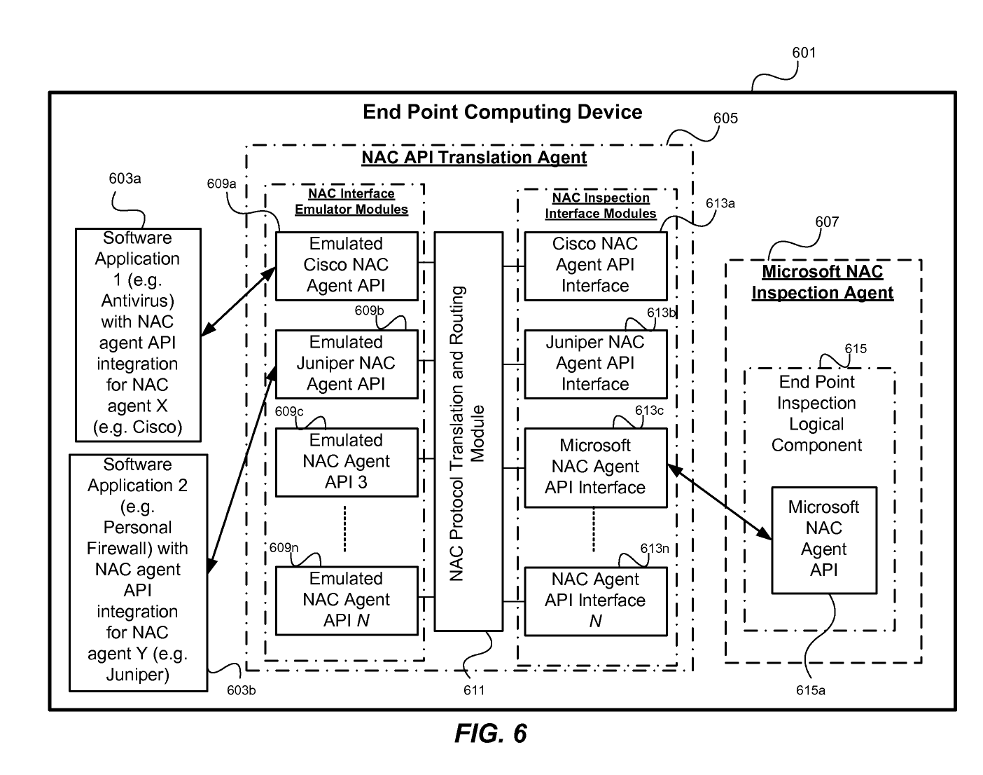

FIG. 6 depicts an alternative embodiment of an NAC API Translation Agent in accordance with one or more aspects and features described herein. In the embodiment shown in FIG. 6, an NAC API Translation Agent can simultaneously support two or more software applications which each support a different NAC agent API and allow the applications to support an altogether different NAC agent API that the software applications do not natively support.

In the example shown in FIG. 6, a first software application 603a supports one NAC agent API, in this example the Cisco® Trust Agent API, and a second software application 603b supports a second NAC agent API, in this example the Juniper® NAC client. The organization Microsoft® Network Access Control (NAP) as its NAC solution and so Microsoft® NAC client 607 is installed on the end point computing device 601. Because the Cisco®, Juniper® and Microsoft® NAC APIs are incompatible, the software applications 603a, 603b are unable to directly communicate with the NAC Inspection Agent 607.

In accordance with aspects described in more detail below, an NAC API Translation Agent can simultaneously emulate multiple different specific NAC agent APIs. In the exemplary embodiment shown in FIG. 6, NAC API Translation Agent 605 can emulate both Cisco® Trust Agent API 609a and Juniper® NAC Agent API 609b. This can allow the first software application 603a to communicate end point inspection results using the Cisco® Trust Agent API 609a it was designed to support. This also allows the second software application 603b to communicate end point inspection results using Juniper® NAC API 609b it was designed to support. NAC API Translation Agent 605 Protocol Translation and Routing Module logic component 611 can act as a translation and routing intermediary between software applications 603a and 603b, on the one hand, and Microsoft® NAC Inspection Agent 607, having an End Point Inspection Logical Component 615 using the Microsoft® NAC agent API 615a, and can translate messages passed between one or more of software applications 603a and 603b and Microsoft® NAC Inspection Agent 607 so that, for example, the results of an end point inspection made using software application 603a can be passed to End Point Inspection Logical Component 615 in the organization's Microsoft® NAC Inspection Agent 607 and ultimately to a Microsoft® NAC policy assessment server.

This capability allows an organization to simultaneously use different software applications that support different NAC agent APIs while only requiring one NAC agent to be installed on the end point. This capability also allows an organization to select the best NAC solution and NAC agent for its needs regardless of whether or not all existing software applications support that particular NAC agent's API.

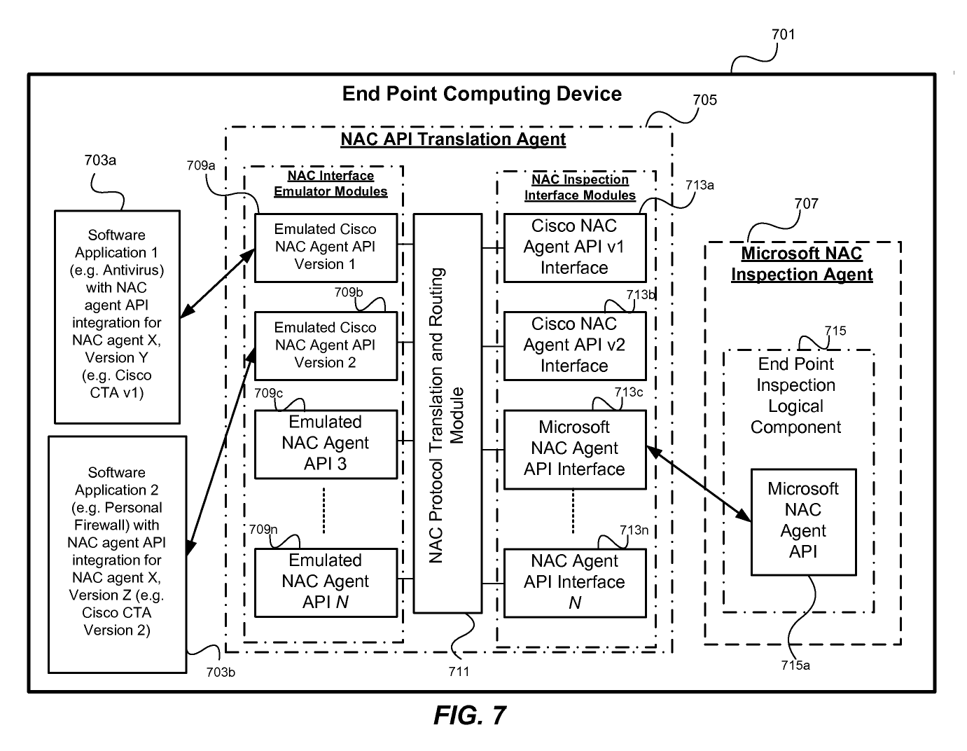

In another embodiment, for example, as shown in FIG. 7, an NAC API Translation Agent in accordance with aspects and features described herein can be a very useful tool when an organization upgrades their NAC solution and NAC agent to a new version (e.g. migrate from Juniper® v1 to Juniper® v2) and such an upgrade results in a different API being used by the NAC agent installed on the end point or replaces their NAC solution vendor (e.g. migrates from Cisco® to Juniper®) and such a replacement results in a different API being used by the NAC agent installed on the end point. In either case, a software application that was written to integrate to a specific API version may no longer be able to communicate end point inspection results because the software application does not support the newly installed NAC agent's API.

Rather than force the organization to also replace the software application with a newer version or one from a different vendor that supports the new NAC agent API, an NAC API Translation Agent can be used to solve the problem. The NAC API Translation Agent can allow a software application to continue to integrate with the same NAC agent API that the software application originally integrated with, for example, Cisco® CTA API while also allowing the application to communicate with the newer, different NAC agent vendor or version. This can save the organization money because the software application will not need to be upgraded or replaced with an application that can communicate with a new NAC agent API. It also can ensure that the software application can continue to report end point inspection results to the network so that only properly protected end points are able to connect to the network.

In the exemplary embodiment of such a scenario shown in FIG. 7, end point computing device 701 has two software applications residing in the device, software application 703a (e.g. an Antivirus Security Agent), which supports integration with NAC agent X, Version Y (e.g., Cisco® CTA, Version 1), and software application 703b (e.g. a Personal Firewall Security Agent), which supports integration with NAC agent X, Version Z (e.g. Cisco® CTA, Version 2). As shown in FIG. 7, communication from software application 703a or software application 703b can go through NAC API Translation Agent 705 that emulates a Cisco® CTA NAC Agent API Version 1 709a as well as emulates a Cisco® CTA NAC Agent API Version 2 709b, through NAC Protocol Translation and Routing Module logic 711 and then to NAC API Translation Agent 705 Microsoft NAC Agent API Interface 713c before reaching the End Point Inspection Logical Component 715 residing within the Microsoft NAC Inspection Agent 707 via the Microsoft® NAC Agent API 715a. Thus, the example in FIG. 7 shows two different software applications that each support a different NAC agent API version, with the NAC API Translation Agent 705 providing translation services and isolating the two software applications from changes in the NAC agent API used by the organization and running on the end point.

Software application migration is the opposite of NAC agent migration. In this scenario, the organization needs to or elects to replace a software application. The old software application did support the NAC agent API and was successfully integrated, however the new software application does not. The following hypothetical example illustrates the point: Assume the organization was using the Symantec Antivirus agent which supports the Cisco® Trust (NAC) Agent API. The organization is also using the Cisco® Trust Agent. The organization wants to replace the Symantec Antivirus agent with the McAfee® Antivirus agent. The McAfee® agent supports the Juniper® NAC agent API, but not the Cisco® Trust Agent API. The organization must find some way to get the McAfee® agent to communicate with the Cisco® Trust Agent using the Cisco® Trust Agent API. An NAC API Translation Agent in accordance with one or more aspects and features described herein can bridge this gap, translating messages to/from the McAfee® Antivirus agent that are formatted in accordance with the Juniper® NAC agent API requirements to messages formatted in accordance with the Cisco® Trust Agent API, and then relaying messages to/from the Cisco® Trust Agent via the Cisco® Trust Agent API.

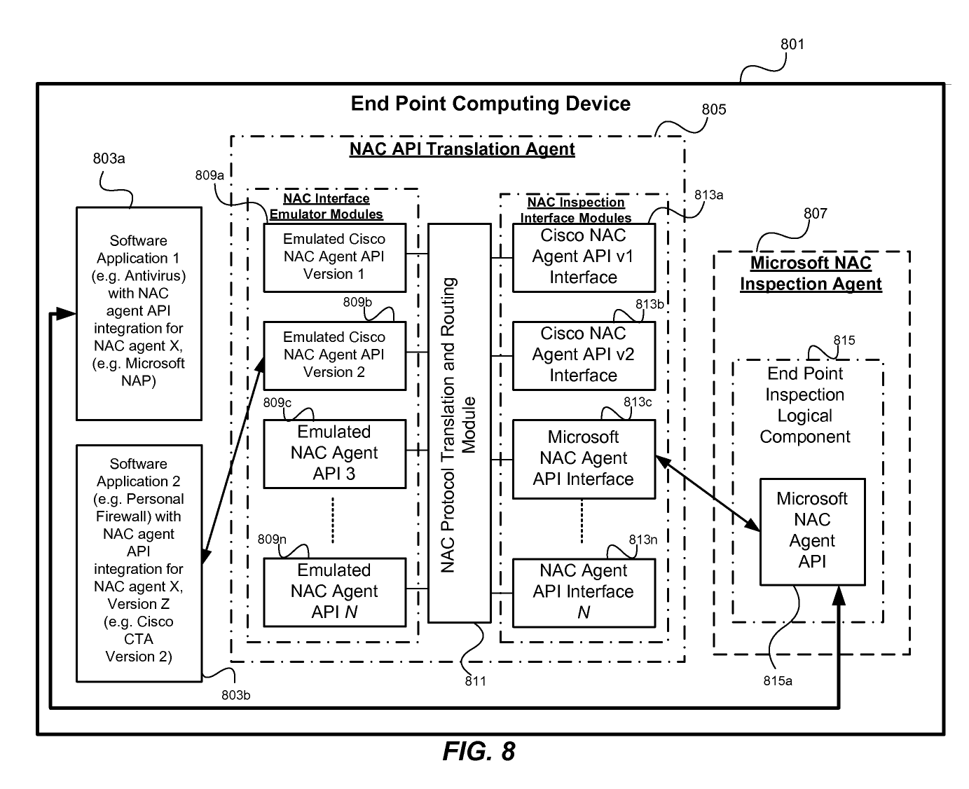

Alternatively, when there are multiple software applications on the end point computing device, some of which support the desired NAC agent API, and some of which do not, an NAC API Translation Agent can be used for those software applications that do not natively support the desired NAC agent API, and can operate alongside those applications that do natively support the desired NAC agent API. FIG. 8 shows one exemplary configuration where an end point computing device 801 houses a first software application 803a that natively supports the desired NAC agent API, e.g., the Microsoft® NAC Agent API, and a second application 803b that does not. As shown in FIG. 8, software application 803a can communicate directly with Microsoft® NAC Inspection Agent 807 and End Point Inspection Logical Component 815 via Microsoft® NAC Agent API 815a. In accordance with aspects described herein, software application 803b also can communicate with Microsoft® NAC Inspection Agent 807 by way of NAC API Translation Agent 805. As shown in FIG. 8, communication from software application 803b, which supports a different NAC agent, e.g., a Cisco® CTA API Version 2, can go through Cisco® CTA API Version 2 emulator 809b and the NAC Protocol Translation and Routing Module logic 811 in the NAC API Translation Agent 805, which translates the message from software application 803b into a message compatible with Microsoft® NAC Agent API 815a and thus one that can be read and understood by Microsoft® NAC Inspection Agent 807. Thus, the exemplary embodiment shown in FIG. 8 illustrates how an NAC API Translation Agent in accordance with one or more aspects and features described herein can be used alongside software applications that natively support the desired NAC agent API and how an NAC API Translation Agent can supplement those software applications that do not natively support the desired NAC agent API to permit such applications to communicate with NAC agents to protect the network against malware or other attacks.

An NAC API Translation Agent in accordance with one or more aspects described herein can comprise three main components and two data repositories:

A plurality of NAC Interface Emulator Modules;

A single Protocol Translation and Routing Module; and

A plurality of NAC Inspection Agent Interface Modules

A single data repository that contains Configuration Settings and NAC Protocol/NAC API Translation Tables.

A single data repository that contains Diagnostic Logging Events of interest.

The operation of these components will be described in more detail below.

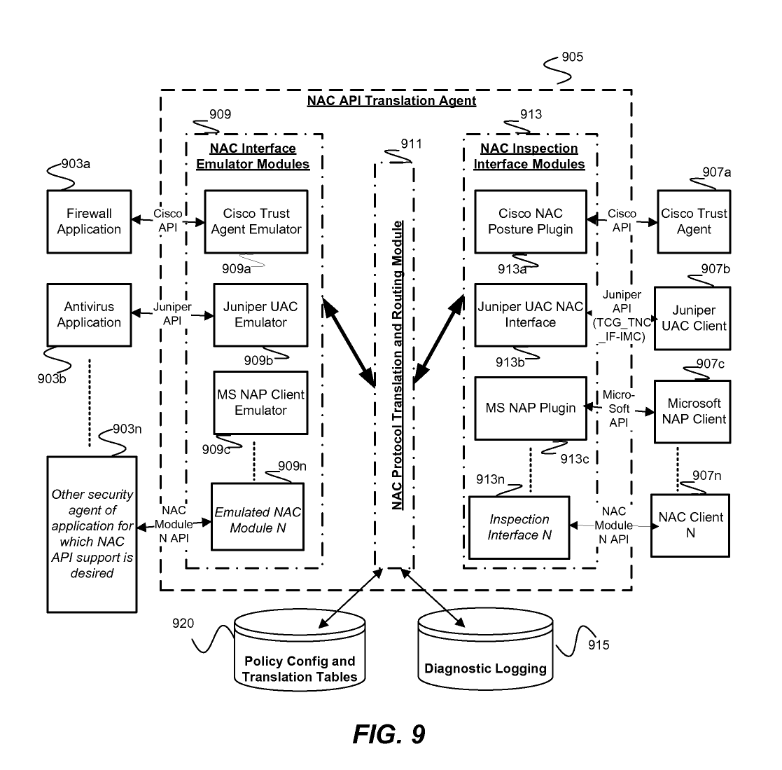

An exemplary embodiment of an NAC API Translation Agent showing these Components and Modules is shown in FIG. 9. As shown in FIG. 9, and as described above, NAC API Translation Agent 905 can comprise a plurality of NAC Interface Emulator Modules 909, an NAC Protocol Translation and Routing Module 911, and a plurality of NAC Inspection Interface Modules 913 that can support different NAC Agent API vendors and versions 907a, 907b, 907c . . . 907n. As shown in FIG. 9, and as described in more detail below, NAC Protocol Translation and Routing Module 11 can communicate with each of NAC Interface Emulator Modules 909 and NAC Inspection Interface Modules 913, and also can communicate with Policy Configuration and Translation Tables 920 stored in persistent memory and with Diagnostic Logging 915 stored in persistent memory.

FIG. 9 also shows how an NAC API Translation Agent can interface with end point security applications and other end point applications for which NAC client integration is of interest. Also shown are example NAC clients to which the end point security applications and other end point applications may want to integrate but for which support for a particular NAC client Vendor API or a particular NAC client API Version does not exist. For example, Firewall Application 903a may be compatible with the Cisco® NAC Agent API but wishes to report end point inspection results such as PERSONAL_FIREWALL_VENDOR=Internet_Security_Systems, PERSONAL_FIREWALL_VERSION=5.3, PERSONAL_FIREWALL_RUNNING_STATE=active, PERSONAL_FIREWALL_LAST_POLICY_UPDATE_DATE=2007-05-30, or PERSONAL_FIREWALL_THREAT_STATUS=0 to a Microsoft® NAC Client 907c which uses the Microsoft® NAC API.

Alternatively, Antivirus Application 903b may be compatible with the Juniper® NAC Agent API but wishes to report end point inspection results such as ANTIVIRUS_VENDOR=Symantec®, ANTIVIRUS_VERSION=10.5.0.1, ANTIVIRUS_RUNNING_STATE=active, ANTIVIRUS_LAST_UPDATE=20071129, or ANTIVIRUS_FILE_SYSTEM_PROTECTION_STATE=1 to a Cisco® CTA Client Version 2 API 907a. Using Firewall Application 903a as exemplary, communication between the application and the NAC agent residing on the end point computing device can be accomplished as follows. A message from Firewall Application 903a which is formatted according to a Cisco® NAC Agent API, for example, identifying the personal firewall vendor, version, running state and last update date, can be routed through Cisco® Trust Agent Emulator module 909a to NAC Protocol Translation and Routing Module 911. Using one or more of Policy Configuration and Translation Tables in memory 920, NAC Protocol Translation and Routing Module 911 can translate the message to a message formatted according to the API used by the NAC client installed on the end point computing device, for example, the Microsoft® NAP Client 907c. The translated message can be routed to the appropriate NAC Inspection Interface Module 913, in this example, to Microsoft® NAP Plugin 913c, which can then forward the message from Firewall Application 903a to Microsoft® NAP Client 907c, which can successfully process the message containing end point inspection results because it has been translated by the NAC Protocol Translation and Routing Module 911 to the proper syntax and format as required by the Microsoft® NAC API.

In an alternative embodiment, if two or more software applications, e.g., a Personal Firewall Agent 903a and an Antivirus Agent 903b, require NAC API translation support by the NAC API Translation Agent, the NAC API Translation Agent can load two or more instances, or “threads,” of a particular NAC Interface Emulator Module (e.g. two instances of an emulated Cisco® NAC Posture Plugin application 909a). Each such Module can interface with a specific software application, e.g. the Personal Firewall Agent 903a or Antivirus Agent 903b mentioned above, so that Translation and Routing Module 911 can provide registration and translation services on behalf of those two or more software applications.

The modular design of an NAC API Translation Agent in accordance with one or more aspects described herein provides can have many benefits. For example, it can provide a flexible framework to easily add and support additional NAC agents and particular NAC agent APIs. In addition, the modules can be implemented as libraries that can be updated independently, both of other modules and of the main application. The modular design also enables additional interfaces to be supported or new versions of already supported interfaces to be added without having to upgrade the entire application. This also enables unneeded libraries to be removed, reducing the overall size of the NAC API Translation Agent and thus improving performance. In addition, the modular design of NAC API Translation Agent 905 enables programming errors or bugs in one module to be fixed and updated without having to update the entire NAC translation agent application 905.

A second benefit of an NAC API Translation Agent in accordance with one or more aspects and features described herein is that behaviors and capabilities can be driven by easily configurable and easily extensible configuration policy settings and translation tables 920. As further described below, a policy-driven configuration provides the ability to easily and dynamically add and subtract support for new NAC agents and NAC agent APIs as applications are added or changed on the end point device. Along with a policy base configuration, the translation mapping between vendor interfaces can be table-driven. As described in more detail below, translation tables can also be easily and dynamically updated as new interface modules are added without having to upgrade the entire application.

In an exemplary embodiment, an NAC API Translation Agent in accordance with one or more aspects and features described herein can be implemented as a system service, or “daemon,” that runs in the background from the time the device is started and until it is shutdown. In alternative embodiments, it also could be implemented as an application that starts on demand from a user, an application that is automatically started when another application is started, or an application that is automatically started in response to a particular system event.

When an NAC API Translation Agent in accordance with one or more aspects herein is started, the main software program executable can load into memory and begin executing a series of programmatically defined initialization tasks, including loading the NAC Protocol Translation and Routing Module, querying the Policy Configuration and Translation Tables to determine which NAC Interface Emulator Module(s) to load into memory (or alternatively simply loading every NAC Interface Emulator Module), querying the Policy Configuration and Translation Tables to determine which NAC Inspection Interface Module(s) to load into memory (or alternatively simply loading every NAC Inspection Interface Module), and executing any NAC agent specific registration tasks necessary to make the NAC agent(s) installed on the end point aware that the NAC API Translation Agent is a software application wishing to communicate with and report end point inspection results to the NAC agent(s).

Other programmatically defined initialization tasks can also be performed during the startup process as, appropriate or necessary for the situation. Individual NAC Interface Emulator Modules and/or individual NAC Inspection Interface Modules can initiate their own series of programmatically defined tasks, including but not limited to querying the Policy Configuration and Translation Tables for configuration information and then acting on that information as appropriate. One task performed by NAC Interface Emulator modules is determining what software applications installed on the end point computing device have registered to report end point inspection results to an NAC agent. That information, along with information regarding the currently installed NAC Agent(s) on the end point computing device can be used by the NAC API Translation Agent to perform registration tasks on the software application's behalf so that an NAC Agent not natively supported by the software application can be made aware of the software application's presence and its interest in reporting end point inspection results to the NAC Agent.

The discussion below provides a more detailed description of some exemplary embodiments of components and modules that can be used in an NAC API Translation Agent in accordance with one or more aspects and features herein. To illustrate aspects of the an API translation system and method as described herein, detailed examples are discussed in the context of two representative NAC agents (Cisco® and Juniper®) and NAC agent APIs (Cisco® and TNC). Note that as previously described above, the Juniper® NAC agent recently adopted support for the TCG™ TNC IF-IMC API as its NAC Agent API, therefore the terms “Juniper® NAC Agent API” and “TCG™ TNC NAC Agent IF-IMC API” (hereinafter “TNC API”) are considered identical, and as illustrated and described herein refer to the Juniper® NAC agent API whose message syntax and content is as defined by the TCG™ TNC IF-IMC Interface Specification, a publicly available document. Those skilled in the art will readily observe that the NAC API Translation Agent discussed below can be equally capable of supporting additional NAC agents and translating between additional NAC agent APIs and is not limited to the specific examples described herein.

The Cisco® NAC agent API and the TNC API are a series of vendor-specific software modules developed according to specifications and requirements of the vendor or standards developer, as the case may be. For example, the Cisco® NAC agent API is developed according to specifications and requirements relating to Cisco's NAC equipment and software, whereas the TNC API is developed according to specifications and requirements intended to provide an industry standard, but will interface only with equipment that also use that standard. In either case, these APIs can be used to directly interface to a specific vendor's NAC client to receive one or more different types of NAC request messages and then provide one or more different types of NAC response messages including but not limited to end point inspection results.

By industry convention, it is assumed by the NAC agent vendor that the NAC agent is directly communicating with the end point security agent (or another user application for which NAC integration is of interest). However, by using an NAC API Translation Agent in accordance with aspects and features described herein, the NAC agent can communicate with the NAC API translation agent, which can then translate and route messages between the NAC agent using one NAC agent API and the end point security agent (or another user application) using a different NAC agent API.

It can be understood by persons skilled in the art that terminology can vary based on the vendor or standard used. For example, Cisco Systems® refers to the software application (e.g. Personal Firewall Agent, Antivirus Agent) with which the Cisco® Trust Agent is communicating as a “Cisco NAC Posture Plugin” or simply a “posture plug-in” that returns end point inspection results in the form of “posture credentials” over the “posture agent API” to the “posture agent” (i.e. the Cisco® Trust Agent). As another example, the Trusted Computing Group (TCG™) refers to the software application (e.g. Personal Firewall Agent, Antivirus Agent) as an “end point Integrity Measurement Collector (IMC)” that communicates end point inspection results in the form of “end point posture integrity measurements” over the “IMC Interface (IF-IMC)” API to the “Trusted Network Connect (TNC) Client”, which is any NAC agent implementing an NAC Agent API which conforms to the TCG™ TNC IF-IMC Interface Specification. In accordance with conventions in the art, vendors can often supply Software Development Kits (SDKs) and sample code to aid software developers in writing code that is compatible with their specific equipment or software. Such software development kits can also be used by practitioners in implementing an NAC API Translation Agent in accordance with one or more aspects and features described herein.

As shown in FIG. 9, each specific inspection interface module 913a, 913b . . . 913n also can interface with NAC Protocol Translation and Routing Module 911. Each specific inspection interface module 913a . . . 913n can deliver the NAC request or NAC command from the NAC agent, for example, Cisco® Trust Agent 907a, Juniper® UAC Client 907b, etc. to NAC Protocol Translation and Routing Module 911 and then efficiently wait for a response from an end point security agent such as Firewall Application 903a, Antivirus Application 903b, or other security agent 903n so that a response can be returned to the NAC agent. In most cases, the data interface to Protocol Translation and Routing Module 909 will be in the native vendor or standards-based forma, whether the Module is sending or receiving NAC information, or sending or receiving with any return codes.

In accordance with aspects herein, an NAC Inspection Interface Module 913 can be implemented as a multi-threaded process. For example, one thread can be waiting on NAC input requests from the vendor NAC agent (for example, Cisco® Trust Agent 907a shown in FIG. 9), while another thread waits on responses from an endpoint security agent (for example, Firewall Application 903a shown in FIG. 9) via Protocol Translation and Routing Module 911 to pass those responses back to the vendor NAC agent. This multi-threaded design can allow the NAC Inspection Interface Module 911 to always be available to process incoming requests or commands from an NAC Agent.

To accomplish the goals of an NAC API Translation Agent in accordance with one or more aspects and features described herein, the individual NAC Inspection Interface Modules 913a . . . 913n can perform the following functions:

Initialize with NAC Protocol Translation and Routing Module 911 and register with the specific vendor interface, for example, the Cisco® Trust Agent Posture Plugin API;

Process NAC requests, responses, and notifications from the NAC Agent, e.g. 907a, 907b . . . 907n, end point security or other applications, e.g. 903a, 903b . . . 903n, and the end point computing device operating system; and

On shutdown, cleanly disconnect in an orderly fashion from the NAC Agent interface.

In accordance with aspects described herein, each of these tasks can be implemented as an abstract interface, or facade, supported by all NAC Inspection Interfaces 913a, 913b . . . 913n.

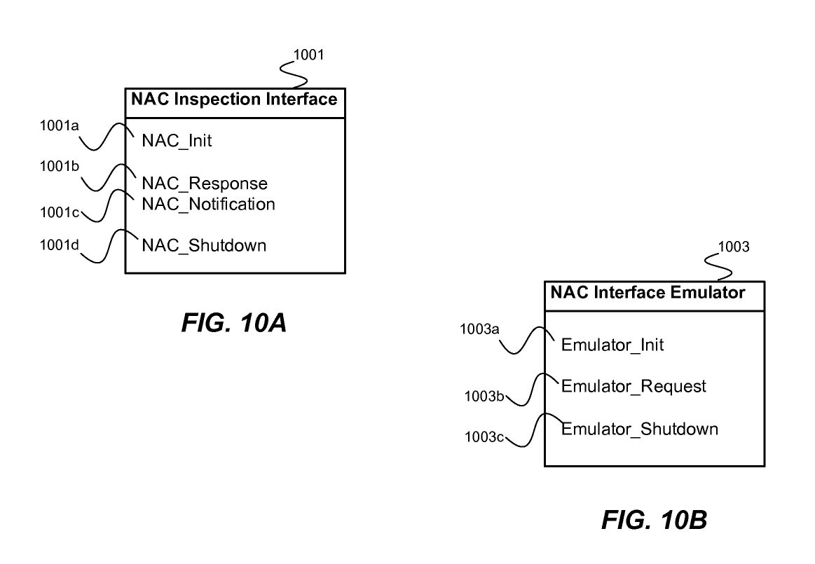

Exemplary NAC API Translation Agent software methods (also known as software functions or software calls) in an NAC Inspection Interface Module are shown in FIG. 10A. As described in more detail below, these functions can include NAC_Init 1001a, NAC_Response 1001b, NAC_Notification 1001c, and NAC_Shutdown 1001d.

The NAC_Init API 1001a shown in FIG. 10A can be called after the NAC Inspection Interfaces library is loaded. It can receive specific policy configuration information at this time. During initialization, registration tasks with the specific vendor interface can be performed by this function.

One or more of the tasks undertaken to register with the vendor's NAC Agent can be vendor specific and can be defined by the NAC agent vendor's API. For example, a Cisco® Trust Agent (CTA) on a Windows platform can create an INF configuration file and can place the posture plug-in DLL and configuration file in the Cisco-defined “posture plug-in directory”, a common, shared folder used by all software applications that communicate directly to the CTA via the CTA API, and thus used by the NAC API Translation Agent. For TCG™ TNC-compliant NAC systems on a Windows platform, a registry key can be created that points to an Integrity Measurement Collector (IMC) stub Dynamic Link Library (DLL), and in such a case, the registry key can be located in a specific file, for example, in a file having a file address “HKLM\Software\Trusted Computing Group\TNC\IMCs hive,” a registration method used by all software applications that communicate directly to the TCG™ TNC NAC Agent via the IF-IMC API, and thus used by the NAC API Translation Agent.

As noted above, an NAC Inspection Interface Module 913 can be implemented as a multi-threaded process. An input thread can implement the vendor specific API to receive NAC requests. Contents of the request can be buffered and passed to NAC Protocol Translation and Routing Module 911. Some examples of these requests formatted according to a specific API include processPostureRequest for Cisco® Trust Agent and TNC_IMC_Beginhandshake for TNC compliant agents.

The output thread can interface to NAC Protocol Translation and Routing Module 911 via the NAC_Response 1001b and NAC_Notification 1001c APIs shown in FIG. 10A. The output thread can receive a response containing end point inspection results from the end point security agent that is formatted for the vendor specific API and use the specific vendor APIs to return this inspection results data to the vendor specific agent. For example, a response from Firewall Application 903a can be directed to the Cisco® Trust Agent 907a, can be formatted and have syntax in accordance with the Cisco® Trust Agent API Specification, and be intended to be sent to the Cisco® Trust Agent via Cisco Posture Plugin API shown in FIG. 9. In accordance with processing protocols used in the art, for the Cisco Trust NAC agent, the response can be returned using a processPostureRequest message, while notifications can use a queryPostureStatusChange message. For TNC compliant agents (e.g. Juniper® UAC NAC agent using a TCG™ TNC-compliant IF-IMC API), the responses can be returned using the TNC_TNCC_SendMessage message, and notifications can be returned using, for example, the TNC_TNCC_RequestHandshakeRetry message.

The NAC_Shutdown API 1001d can be called when the NAC Translation Agent is closing down. In accordance with processing protocols used in the art, an NAC Inspection Interface module 1001 should notify its respective vendor agent, for example, Cisco® Trust Agent 907a, Juniper® UAC client 907c, etc. shown in FIG. 9 that the device is closing, and any conversations that are in progress should be terminated and appropriate error codes returned.

FIG. 10B depicts architecture for an exemplary NAC Interface Emulator software module 1003. In accordance with one or more aspects and features described herein, the NAC Interface Emulator Module 909 shown in FIG. 9 comprises a series of software modules that can emulate a vendor-specific or standards-specific NAC agent interface or API. These software modules can be used to interface to an application being inspected, for example, an end point security agent such as a Firewall Application 903a or Antivirus Application 903b, or another application 903n for which NAC agent integration is of interest, using vendor specific or standards-specific API and data formats. In Cisco terms, this would be the posture plug-in interface, and in TCG™ terms, this would be the Integrity Measurement Collector Interface (IF-IMC). An NAC Interface Emulator software module 1003 can support both the interface API along with the Attribute Value Pair (AVP) data format and return codes.

To accomplish the goals of an NAC API Translation Agent in accordance with one or more aspects and features described herein, the individual NAC Interface Emulator Modules 909a . . . 909n can perform the following functions:

Initialize with the configured applications;

Forward NAC Requests to the application;

Return NAC Responses and Notifications received from the end point applications to the NAC Protocol Translation and Routing Module; and

On shutdown, cleanly disconnect with the application interface.

In accordance with aspects described herein, each of these tasks can be implemented as an abstract interface or facade supported by each of NAC Interface Emulators 909a, 909b . . . 909n.

Exemplary NAC API Translation Agent software methods (also known as software functions or software calls) in an NAC Interface Emulator Module 1003 are shown in FIG. 10B. As shown in FIG. 10B, these exemplary functions can include an Emulator_Init API 1003a, an Emulator_Request API 1003b, and an Emulator_Shutdown API 1003c.

In accordance with aspects herein, Emulator_Init API 1003a can be called after an NAC Interface Emulator library is loaded as part of the startup process previously described. This software module can receive specific policy configuration information at this time.

During initialization of the NAC API Translation Agent, all initialization tasks of individual applications can also be performed. In accordance with protocols known in the art, the tasks necessary to initialize with a configured software application wishing to communicate to a specific NAC Agent are vendor- and application-specific. For example, for a Cisco® Trust Agent 907a acting on a Windows® platform and a software application such as an antivirus application wishing to communicate with that Cisco® Trust Agent, in accordance with procedures known in the art, the software application such as an antivirus application (known as a “posture plug-in application” in Cisco parlance) creates INF configuration files and places posture plug-in DLLs and the INF configuration files in the Cisco® Trust Agent posture plug-in directory on the end point computing device. The Cisco® Trust Agent NAC Agent only looks in the posture plug-in directory to learn about what software applications are on the end point computing device that want to communicate with the Cisco® Trust Agent. As part of NAC API Translation Agent initialization, Cisco® Trust Agent Emulator 909a can search the end point computing device folder structure for these particular files, and from their presence learn of the particular type and properties of the software application wishing to communicate with and supporting API integration with a Cisco® Trust Agent. Based on the specific NAC Agent currently running on the end point computing device or in accordance with a policy-based configuration setting stored in the Policy Configuration and Translation Tables 920, the NAC API Translation Agent 905 thus performs, on behalf of a software application such as an antivirus application wishing to communicate with a Cisco® Trust Agent, the vendor- and application-specific tasks necessary to initialize the software application in accordance with the initialization method required by the actual NAC Agent 405 in use or planned to be used on the end point computing device, for example a Juniper® Networks NAC Agent 907b using the TCG™ TNC IF-IMC NAC Agent API.

Similarly, the NAC API Translation Agent 905 can load instances of the Cisco® NAC Posture Plugin 913a into the Cisco® posture plugin directory, where each instance represents or emulates a single particular software application such as a personal firewall agent 903a or an antivirus agent 903b. This load process will enable the Cisco® Trust Agent to discover the software applications wishing to communicate with it.

As a second example, an end point computing device may have a TCG™ TNC-based NAC Agent such as Juniper UAC Client 907b acting on a Windows platform and a software application such as a personal firewall (known in TCG™ parlance as an “integrity measurement collector” or “IMC”) wishing to communicate with that TCG™ TNC-based NAC Agent. In accordance with procedures known in the art, the software application installs an IMC stub DLL in a directory of the software application's choosing when the software application is installed on the device. The software application must also create a Windows registry key that specifies the file name and directory path where the IMC stub DLL is located. The TCG™ TNC-compliant NAC Agent, e.g. the Juniper® UAC Client 907b only examines this registry key to learn about what software applications are on the end point computing device that want to communicate with the TCG™ TNC-compliant NAC Agent.

As part of the NAC API Translation Agent initialization, Juniper® UAC Emulator 909b can search the Windows registry for these particular keys, and from their presence learn of the particular type and properties of the software application wishing to communicate with and supporting API integration with the TCG™ TNC-compliant NAC Agent. Based on the specific NAC Agent currently running on the end point computing device or in accordance with a policy-based configuration setting stored in the Policy Configuration and Translation Tables 920, the NAC API Translation Agent 905 thus performs, on behalf of a software application such as a personal firewall application wishing to communicate with a TCG™TNC-compliant NAC Agent, the vendor- and application-specific tasks necessary to initialize the software application in accordance with the initialization method required by the actual NAC Agent 405 in use or planned to be used on the end point computing device, for example a Cisco® Trust Agent 907a using the Posture Plugin API.

Similarly, the NAC API Translation Agent 905 can load instances of the Juniper® UAC NAC Interface 913b into a system folder and create a Windows registry key specifying the name and system path for each instance, where each instance represents or emulates a single particular software application such as a personal firewall agent 903a or an antivirus agent 903b. This load process will enable the TCG™ TNC-compliant NAC Agent such as the Juniper® UAC Client to discover the software applications wishing to communicate with it.

In accordance with one or more aspects and features described herein, NAC Interface Emulator Modules 909 can thus determine what installed software applications have registered to report end point inspection results using the process defined by and used by the specific NAC agent. Furthermore, the NAC API Translation Agent 905 can thus perform, in accordance with one or more aspects described herein, a NAC Agent-specific registration action on a software application's behalf so that the NAC Agent currently installed on the end point knows to query and expect end point inspection results from the software application using the software application detection method specific to and unique to that NAC Agent, the appropriate registration action required for that NAC agent not supported by or performed by a software application because the software application supports a different NAC agent and performs a different registration action specific to the different NAC Agent.

In accordance with some aspects and features described herein, this registration action can be performed by NAC Protocol Translation and Routing Module 911, though it is contemplated and within the scope of the present disclosure that any of the components of the NAC API Translation Agent 905 can perform this registration action.

As previously described, the specific registration actions vary widely and are unique for each vendor NAC solution. The NAC API Translation Agent 905 is similarly able to perform many other types of NAC Agent-specific registration actions for each NAC Agent it supports on behalf of each software application.

Like NAC Inspection Interface 909, NAC Interface Emulator 913 can be implemented as a multi-threaded process. One thread can be waiting on requests from NAC Protocol Translation and Routing Module 911 to initiate a posture request to the end point software application, while the other thread waits for the software application response(s) and notifications. This multi-threaded design can allow NAC Interface Emulator 909 to always be available to process incoming events. In accordance with one or more aspects described herein, NAC Protocol Translation and Routing Module 911 can simultaneously support multiple end point applications, using either the same NAC Interface Emulator for all or different NAC Interface Emulators for one or more applications. This is true both for the NAC Interface Emulator Modules 909 side as well as the NAC Inspection Interface Modules 913 side.

The input thread can interface to NAC Protocol Translation and Routing Module 909 via an Emulator_Request API 1003b shown in FIG. 10B. Using this API, the input thread of NAC Interface Emulator 1003 can receive a request formatted for a specific application and use the specific vendor API to send this posture request to the software application. For example, for a Cisco® Trust Agent, the request for information regarding an end point's security or other software posture can be made using a processPostureRequest message formatted in accordance with the Cisco® Trust Agent API. Alternatively, for TNC compliant agents, a security information request can be initiated using messages formatted in accordance with the TCG™ TNC IF-IMC NAC Agent API, such as TNC_IMC_Beginhandshake, TNC_IMC_ReceiveMessage, or TNC_IMC_BatchEnding.

The output thread can implement a vendor-specific API to receive NAC responses and notifications from an end point security application written in accordance with that specific API. Contents of the responses, for example, responses from Firewall Application 903a using a Cisco® API or Antivirus Application 903b using a Juniper® API are buffered and then passed to Protocol Translation and Routing Module 909 by using either the Emulator_Response 1001b or Emulator_Notification 1001c API. As noted above, some examples of these messages include processPostureRequest message formatted according to the Cisco® Trust Agent and a TNC_TNCC_SendMessage for TNC-compliant agents.

The Emulator_Shutdown API 1003c shown in FIG. 10B can be called when the NAC API Translation Agent is closing down. At that time, the NAC Interface Emulator modules 909 can notify the software applications the device is closing and libraries loaded during the NAC API Translation Agent startup/initialization phase can be released.

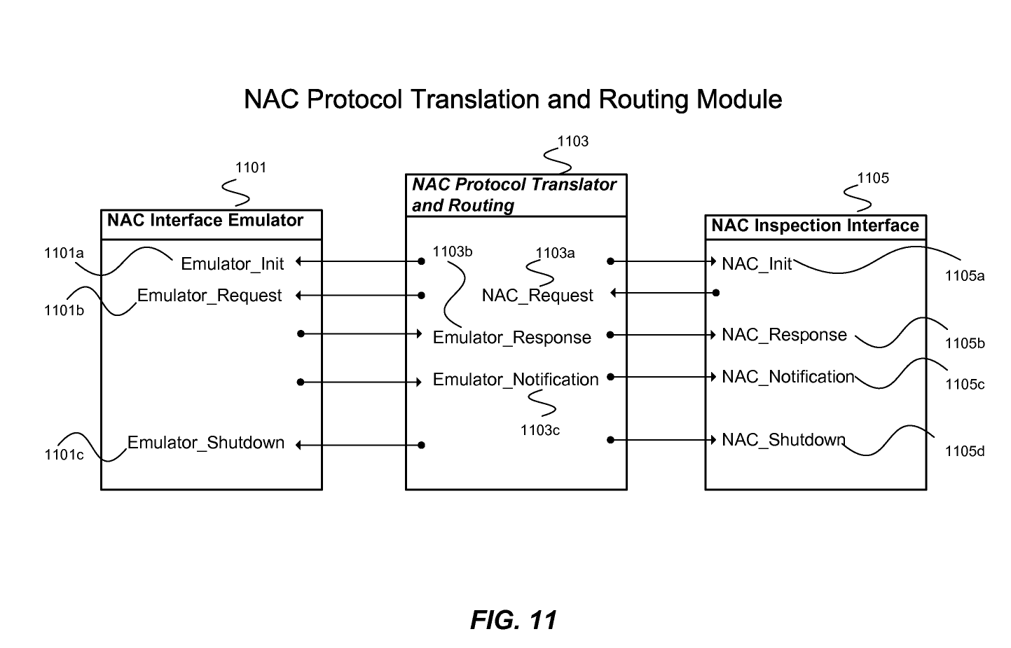

FIG. 11 shows an exemplary configuration for an NAC Protocol Translation and Routing Module 1103 that can be used in an NAC API Translation Agent in accordance with one or more aspects and features described herein. As shown in FIG. 11, this software module can interface to both NAC Interface Emulator 1101 Modules and NAC Inspection Interface 1105 Modules. In accordance with one or more aspects and features described herein, NAC Protocol Translation and Routing Module 1103 can perform the following functions:

Read the policy-based configuration information;

Initialize both the Inspection Interface modules and the NAC Interface Emulator modules;

Route NAC information requests and responses between vendor specific modules;

Translate data between vendor specific interface modules;

Register software applications for required NAC Agents on behalf of installed software applications wishing to report end point inspection results and already registered to use one specific NAC Agent;

On shutdown, terminate all vendor-specific modules; and

Update policy configuration and translation mapping tables.

In accordance with one or more aspects and features described herein, when NAC API Translation Agent 905 is initiated, it can read the policy configuration files and translation mapping tables into memory classes. Based on this configuration it can load any NAC Inspection and NAC Interface Emulator libraries needed to support the range of installed software applications and the range of NAC agents the software applications support, as well as to support the installed NAC Agent. Running an NAC API Translation Agent in this manner can provide the ability to customize and optimize the NAC APIs that are actively running at any given time and is can thus aid in streamlining and improving performance. An alternative embodiment is to simply load all libraries for all of the supported NAC APIs, both on the NAC Inspection Emulator side as well as the NAC Interface side, at initialization.

Once the module libraries are loaded, the NAC_Init 1105a and Emulator_Init 1101a APIs can be called. Upon successful initialization, NAC Interface Emulator Module 1101 can be ready to receive notifications or service requests from a software application (e.g. a Personal Firewall Agent or Antivirus Agent) and can similarly be ready to receive notifications from NAC Protocol Routing and Translator Module 1103. Upon successful initialization, NAC Inspection Interface Module 1105 can be ready to receive notifications or service requests from an NAC Agent (e.g. the Cisco® Trust Agent or Juniper® NAC Client) and can also similarly be ready to receive notifications from NAC Protocol Translation and Routing Module 1103. If a module fails to initialize due to missing libraries, bad or missing configuration entries, applications not registered on the device, unrecognized NAC Agent type, etc., an NAC API Translation Agent in accordance with aspects described herein can attempt to return an error message to the vendor's NAC system and can log diagnostics information specifying the point of failure.

As with the NAC Interface Emulator module 1101 and NAC Inspection Interface module 1105 described above, NAC Protocol Translation and Routing Module 1103 shown in FIG. 11 can be implemented as a multi-threaded process where a pair of threads is created for each NAC application supported. In a manner similar to that described above, one thread can process an input request queue, perform the data translations, and route the request to its applications queue. Messages in the application queue can subsequently be passed to the appropriate NAC Interface Emulator Module 909 and then to the software application 903a, 903b . . . 903n. A second thread can wait for software application responses, perform the reverse data translations, and then routes the response to its vendor NAC queue. Messages in the vendor NAC queue are subsequently passed to the appropriate NAC Inspection Interface Module 913 and then to NAC Agent 907a, 907b . . . 907n.

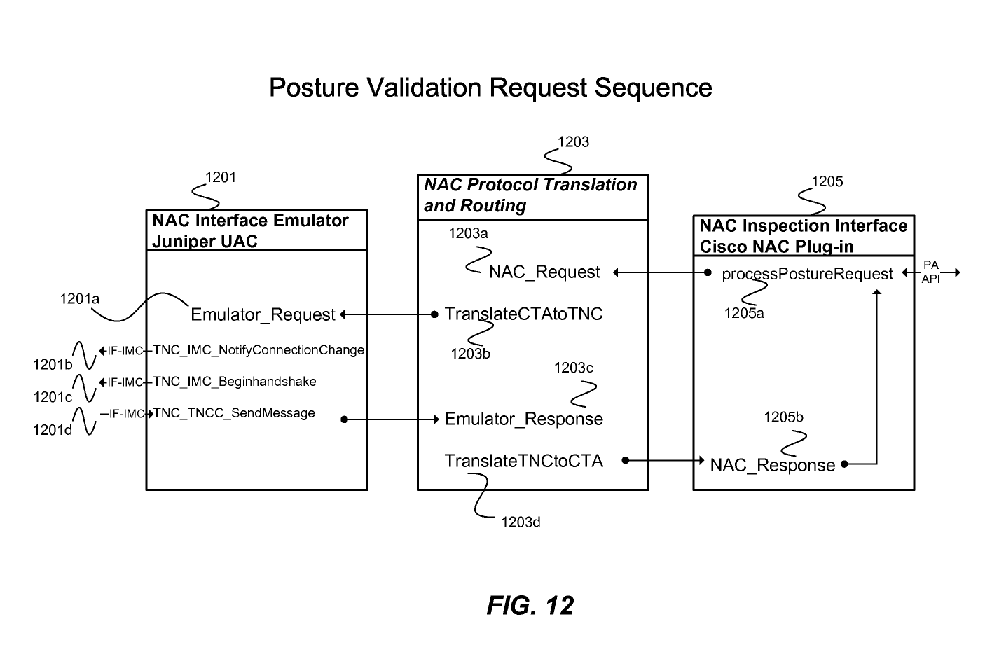

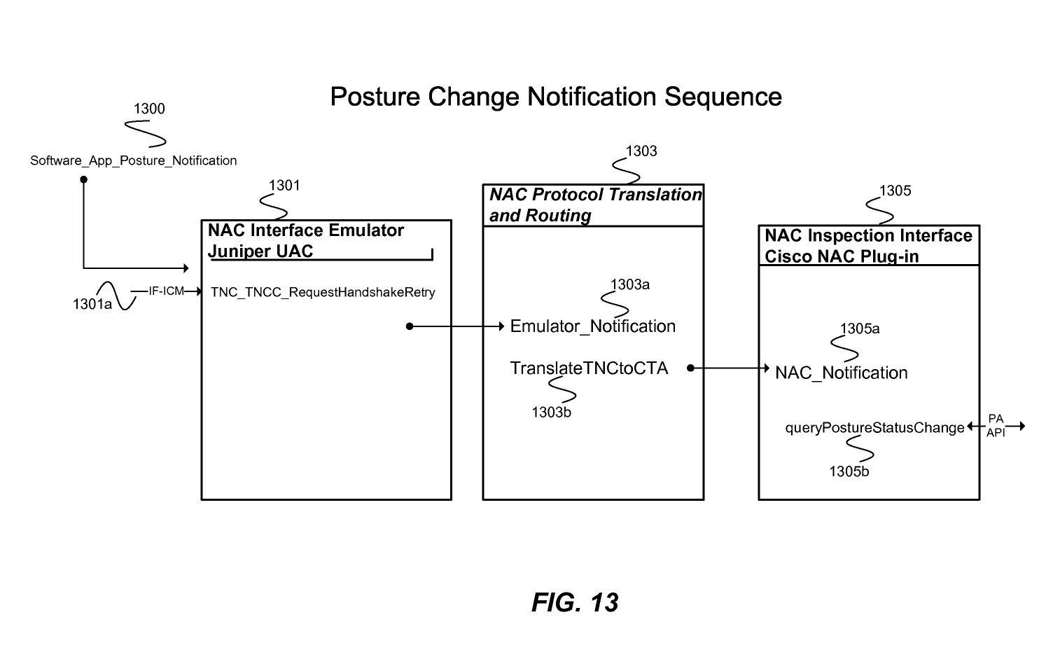

Two exemplary information processing flows in accordance with one or more aspects and features described herein are shown in FIGS. 12 and 13 and will be discussed below.

FIG. 12 depicts a high level example of a request from an NAC agent to a software application (e.g. a Personal Firewall Agent) for end point inspection results. This particular example demonstrates how the NAC API Translation Agent can service a posture validation request from a Cisco® NAC agent (the Cisco® Trust Agent) to an NAC Inspection Interface Emulator module according to aspects herein, and the ensuing response message back to the Cisco® NAC agent (Cisco® Trust Agent), where the ultimate destination of the posture validation request is an end point security agent does not natively support the Cisco® Trust Agent or the Cisco® Trust Agent API, but does natively support the Juniper® NAC Client (the Juniper Universal Access Client [UAC]) and the TCG™ TNC IF-IMC API used by the Juniper® NAC client as its NAC Agent API and thus requires translation and routing via an NAC Protocol Translation and Routing module in accordance with one or more aspects described herein. This example is illustrative of the how the components of an NAC API Translation Agent in accordance with one or more aspects described herein can internally communicate with one another using internal APIs and messaging and how its components can communicate with external software entities, i.e. NAC agents and end point software applications using external APIs and messaging. The example demonstrates how multiple NAC agent APIs, NAC agents, end point security applications and other end point software applications interested in integrating with an NAC client can be supported by an API translation system and method in accordance with one or more aspects described herein.

The sequence shown in FIG. 12 is from right to left and top to bottom:

As shown in FIG. 12, a posture validation request processPostureRequest 1205a can be received by a Cisco® NAC Posture Plug-in Inspection Interface 1205 via the Cisco® Posture Agent API (i.e. the Cisco Trust Agent API). This validation request can then be sent to NAC Protocol Translation and Routing 1203 using NAC_Request API 1203a.

In accordance with one or more aspects and features described herein, a destination end point security application can be identified by Vendor ID and Application Type. An Attribute Value Pair (AVP) data format used by the Cisco® Posture Agent API can be translated to the appropriate format for that end point security application using a table-driven mapping function using mapping data stored in the Policy Configuration and Translation Tables 920. For example, as shown in FIG. 12, using NAC Protocol Translation and Routing 1203 and message TranslateCTAtoTNC 1203b, the request is translated from one formatted and compatible with the Cisco® Trust Agent Posture Plugin API Interface Specification to one formatted and compatible with the TCG™ TNC IF-IMC API Interface Specification.

The translated message can then be routed to the Emulator_Request API 1201a in an NAC Interface Emulator Module, which is in this example is a Juniper® UAC Client NAC Interface Emulator Module. This can cause the Juniper® UAC NAC client NAC Interface Emulator module to create, send, and expect to receive message(s) necessary to communicate the need for an inspection request to the software application (e.g. a Personal Firewall Agent) using message types and message syntax as defined in the TCG™ TNC IF-IMC API Interface Specification. For example, using TNC messaging TNC_IMC_NotifyConnectionCharge 1201b and TNC_IMC_Beginhandshake 1201c, the Juniper® UAC Client NAC Interface Emulator Module 1201 can initiate communication with the security application requesting information regarding the security posture of the device and then await end point inspection results from the software application via a TMC-TNCC_SendMessage 1201d.

When the end point inspection results are received from the software application by way of TNC_TNCC_SendMessage 1201d, the Juniper® UAC Client NAC Interface Emulator Module 1201 can return the data values to the NAC Protocol Translation and Routing Module 1203 using Emulator_Response API 1203c. The posture attributes can then be translated to the Cisco® Trust Agent Attribute Value Pair (AVP) format using a table-driven mapping function by a command Translate TNC to CTA 1203d and the translated information resulting in attributes identified and encapsulated in accordance with the Cisco® Trust Agent Posture Attribute API. The data can then be returned to Cisco® NAC Posture Plug-in 1205 using NAC_Response API 1205b.

The processPostureRequest call can now be completed with posture attributes and a result code indicating success.

FIG. 13 depicts is a high level posture change notification sequence that can be used by an end point software application 903a, 903b . . . 903n to proactively and unilaterally alert the NAC agent 907a, 907b . . . 907n when there is a change in posture in the end point computing device 801. The NAC agent can acknowledge the posture notification, and can then optionally initiate a posture request resulting in an event sequence similar to that just shown in the example above.

The posture change notification sequence shown in FIG. 13 is from left to right and top to bottom:

As shown in FIG. 13, a posture notification message 1300 can be unilaterally generated from a software application, e.g. a Personal Firewall 903a as a result of the software application detecting a security event of interest. The software application will generate a posture notification message that has a syntax consistent with the NAC client API it supports. In this example, the software application supports the Juniper® UAC Client NAC Agent 907b which supports the TCG™ TNC IF-IMC API. Therefore, this software application will generate a posture notification message formatted and structured in accordance with the TCG™ TNC IF-IMC TNC_TNCC_RequestHandshakeRetry message 1301a. The Juniper UAC Agent API Emulator 1301 component of the NAC API Translation Agent 905 monitors for and thus receives this notification message. This posture notification can then be sent to the NAC Protocol Translation and Routing 1303 component using the Emulator_Notification API 1303a.

The message can then be translated to the appropriate message format for the destination NAC agent by the process TranslateTNCtoCTA 1303b shown in FIG. 13. In accordance with one or more aspects and as described in more detail below, this translation can be performed using a table-driven mapping function, which can map a message formatted according to an API used by the source of the message, e.g., according to the TCG™ TNC IF-IMC API, to a message formatted according to an API used the message's destination, in this case according to the Cisco® Trust Agent NAC Agent API, also known as the Posture Attribute (PA) API.

The NAC_Notification API 1305a can then be called, and the Cisco® NAC plug-in can set a notification flag to true. When the Cisco® Trust Agent NAC agent performs its next queryPostureStatusChange periodic poll 1305b, a non-zero value can be returned, which can indicate an end point security posture attribute has changed since the last end point security posture request initiated by the NAC Agent. The NAC Agent can then upload this information to the network or alternatively create a posture validation request and transmit the message to the end point software application in order to obtain more detailed information about the security event.

Once all of the authentication information from the end point computing device is processed, the end point computing device 801 can connect to the network and either obtain full network access if it is in compliance or restricted network access if it must be remediated to be in compliance with the network's policies.

When the end point computing device 801 is being shut down, a notification message is typically broadcast by the operating system. The NAC API Translation Agent 905 can monitor for system shutdown notifications, and upon detection of such notification, shut itself down in an orderly fashion. This includes but is not limited to terminating all active NAC Interface Emulator Module threads 909, terminating all NAC Inspection Interface Module threads 913, logging any session information of interest to the diagnostics logging facility 615 and releasing any memory buffers being held.

As noted above, an NAC API Translation agent can perform translation of messages formatted according to one NAC Agent API into messages formatted according to another, different NAC Agent API by using translation and mapping tables. In accordance with aspects herein an NAC API Translation Agent can be configured to download one or more policy configuration files and translation mapping tables from, for example, an HTTP download site. A configuration parameter stored in a policy configuration settings data store located on the end point computing device can define a URL corresponding to a DNS hostname or IP address of a computing device able to receive update requests from the NAC API Translation Agent and return new configuration settings, an updated translation mapping table, and/or NAC API libraries as needed. Configuration parameters also can exist for time of day to perform the download, retry frequency in case the site is initially unreachable and alternate download sites in case the primary site is unreachable.

An Inspection Interface to NAC Interface Emulator combination can use mapping tables to translate NAC attributes between interfaces. The Input table can map an Inspection Interface attribute to an NAC Interface Emulator attribute and an Output table can map an NAC Interface Emulator attribute back to the Inspection Interface attributes. Both tables can have the format shown below.

| Inspection Interface | | | NAC Interface Emulator | | |
|---|---|---|---|---|---|
| Attribute | Attribute | Attribute | Attribute | Attribute | Attribute |
| Code | Length | Type | Code | Length | Type |

These table attributes are described below. In accordance with one or more aspects, any of the contents of this table can be added, removed, or modified as needed using the update process described above i.e. from an HTTP download site having a policy-defined DNS hostname or IP address.

Attribute Code: A code that is unique per Vendor-ID and Application-Type.

Attribute Length: The maximum length, in bytes, of the attribute value.

Attribute Type: The basic data type of the attribute. Types include String, Integer32, Unsigned32, Octet Array, Time, Version, IPv4Address, and IPv6Address.

In addition, an application that is being serviced by an NAC API Translation Agent can have a configuration entry having the following parameters:

| Parameter | Description |
|---|---|
| Application ID | Name of the application. Used to register with the NAC |
| | Inspection Agent. This is also referred to as a vendor ID. |
| Application | Whether it is a Firewall, Anti-Virus, etc. Used to |
| Type | register with the NAC Inspection Agent. |
| Inspection | Version of the vendor NAC Inspection Agent. Used to |
| Interface | differentiate different API versions when API changes |
| Version | are made by the vendor. |
| Input Mapping | The name of the translation table used to map the |
| Table | Inspection Interface attributes to NAC Interface |
| | Emulator attributes. |
| Inspection | The name of the library that supports the inspection |
| Interface | interface. This module is loaded at run-time and is |
| Implementation | developed according to the NAC vendor's |
| Module | specifications and requirements. |
| Output | The name of the translation table used to map the NAC |
| Mapping Table | Interface Emulator attributes to the Inspection Interface |
| | attributes. |
| NAC Interface | The name of the library that supports the NAC Emulator |
| Emulator | interface. This module is loaded at run-time and is |
| Implementation | developed according to the NAC vendor's |
| Module | specifications and requirements. |
| Inspection | A block of configuration information used to initialize an |
| Interface | Inspection Interface. This is vendor specific |
| Configuration | configuration. |

It can be seen from the above description of end point applications and NAC agents that software applications often support only one or two NAC Agent APIs, yet several may exist. A developer or author of a software program that wants to support a broader set of NAC Agent APIs, including different vendors and/or different versions, must undergo the hardship of designing, coding, testing and distributing a new version of their software application that supports the new NAC Agent API of interest, including NAC Agent-specific registration procedures, if any. This hardship must be repeated for every software application wishing to communicate to a new NAC Agent via a new NAC Agent API. Software developers would benefit from having a specialized NAC API Translation Agent as any software application could automatically support a new NAC Agent API by having the NAC API Translation Agent perform the necessary message translation and registration process on the software application's behalf.

The NAC API Translation Agent can emulate any number of NAC Agent APIs by creating a vendor-specific or standard-specific and version-specific NAC Interface Emulator Module by creating message handlers that emulate the NAC Agent API functionality described and documented in publicly available NAC Agent API programmer reference guides or interface specifications. Similarly, the NAC API Translation Agent can act as a fully NAC Agent API-compliant software application for any number of NAC Agent APIs by creating a NAC Inspection Interface Module that responds to NAC Agent commands and provides notifications to the NAC Agent using message types and message syntax as documented in publicly available NAC Agent API programmer reference guides or interface specifications.

The NAC API Translation Agent can also emulate any number of software applications and communicate with any number of NAC Agents on their behalf by performing any necessary registration actions on each software application's behalf and by emulating or purporting to be a specific software application (e.g. a Personal Firewall Agent, Antivirus Agent, etc.) when exchanging information between a NAC Inspection Interface Module and the actual NAC Agent. The necessary message routing between a given NAC Interface Emulator Module and the appropriate NAC Inspection Interface Module is performed by the NAC Protocol Translation and Routing Module, which also performs the necessary registration actions on each software application's behalf, performs message translation using hard-coded and/or lookup-table driven translations, configures its behavior automatically using policy configuration values obtained from a policy data repository, obtains software, modules and data updates from a download server on a periodic basis and logs diagnostic and Agent events to a Diagnostic Logging data repository.

Although particular embodiments, aspects, and features have been described and illustrated, it should be noted that the invention described herein is not limited to only those embodiments, aspects, and features. It should be readily appreciated that modifications may be made by persons skilled in the art, and the present application contemplates any and all modifications within the spirit and scope of the underlying invention described and claimed herein. Such embodiments are also contemplated to be within the scope and spirit of the present disclosure.

What is claimed is:

1. An application programming interface (API) translation agent for receiving and translating messages supported by a first API into messages supported by a second API, comprising:
a first application interface emulator module, said first application interface emulator module being operatively connected to a first application and being configured to receive a first message from said first application, said first application being configured to communicate in accordance with said first API and said first message being configured in accordance with said first API;
a translation and routing module operatively connected with said interface emulator module; and
a second application interface module, said second application interface module being operatively connected to said translation and routing module and being further operatively connected to a second application, said second application being configured to communicate in accordance with said second API;
wherein said translation and routing module receives said first message from said first application interface emulator module and converts said first message supported by said first API into a second message, said second message being configured in accordance with said second API;
wherein said translation and routing module registers said first application for communication with said second application in accordance with said second application; and
further wherein said second application interface module receives said second message from said translation and routing module and forwards said second message to said second application in accordance with said second API to effect communication from said first application to said second application.

2. The API translation agent of claim 1, wherein said first application, said API translation agent, and said second application reside on an end point computing device.

3. The API translation agent of claim 1, said translation and routing module being operatively connected to at least one translation table, wherein said communication from said first API to said second API is translated according to said translation table.

4. The API translation agent of claim 2, wherein said first message provides information regarding a security posture of said end point computing device, said information regarding said security posture being used in determining whether said end point computing device is in compliance with a security policy of a network.

5. The API translation agent of claim 4, wherein said second application comprises a network access control agent, said network access control agent being part of a network access control system associated with said network, said network access control agent further being configured to communicate with said first application only in accordance with said second API.

6. The API translation agent of claim 5, wherein said first application comprises a firewall application and said first message includes information regarding a status of a firewall residing on said end point computing device.

7. The API translation agent of claim 5, wherein said first application comprises an antivirus application and said first message includes information regarding a status of said antivirus application.

8. The API translation agent of claim 2, wherein said first application comprises an application required by a policy of a said network to be present on said end point computing device, said policy of said network further requiring a predetermined state of said first application, said first message including information used in determining a compliance of said end point computing device with said policy.

9. The API translation agent of claim 4, wherein said second application interface module is further configured to receive a first return message from said second application if said end point computing device is not in compliance with said security policy of said network, said first return message being configured in accordance with said second API;
wherein said translation and routing module is configured to receive said first return message and to convert said first return message into a second return message, said second return message being configured in accordance with said first API;
wherein said first application interface emulator module is configured to receive said second return message; and
wherein said first application receives said second return message from said first application interface emulator module, said first and second return messages including information of a non-compliance of said first application with said security policy of said network.

10. The API translation agent of claim 9, wherein said second return message includes information regarding remediation of said non-compliance of said first application with said security policy of said network.

11. The API translation agent of claim 1, wherein said first application interface emulator module, said translation and routing module, and said second application interface module are initialized upon start-up of the end point computing device.

12. The API translation agent of claim 2, wherein said first message from said first application is in response to a first inquiry from said second application, said first inquiry from said second application being configured in accordance with said second API, wherein said translation and routing module converts said first inquiry from said second application into a corresponding second inquiry, said second inquiry being configured in accordance with said first API such that said second application can obtain information from said first application.

13. The API translation agent of claim 12, wherein said second application comprises a network access control agent, said network access control agent being part of a network access control system associated with a network, and said first inquiry comprises an inquiry regarding a status of said first application on said end point computing device.

14. The API translation agent of claim 2, wherein said first application comprises a firewall application and said first message comprises information of a status of a firewall residing on said end point computing device.

15. The API translation agent of claim 2, wherein said first application comprises an antivirus application and said first message comprises information of a status of said antivirus application.

16. The API translation agent of claim 2, wherein said first application comprises an application required by a policy of a computer network to be present on said end point computing device, said policy of said computer network further requiring a predetermined state of said first application, and said first message includes information used in determining a compliance of said end point computing device with said policy.

17. The API translation agent of claim 1, further comprising:
a plurality of first application interface emulator modules, each of said plurality of first application interface emulator modules being configured to receive a first message from one of a plurality of first applications, each of said first applications communicating according to a first API specific to said each of said first applications;
wherein said translation and routing module receives said plurality of first messages from said plurality of first application interface emulator modules, each of said plurality of first messages being configured in accordance with a different first API;
wherein said translation and routing module registers each of said first applications for communication with said second application in accordance with said second application; and
wherein said translation and routing module converts said plurality of first messages into a corresponding plurality of second messages, each of said second messages being configured in accordance with said second API;
such that each of said first applications communicates with said second application in accordance with said second API.

18. A translation and routing module for an application programming interface (API) translation agent, comprising:
at least one mapping table, said mapping table comprising information regarding attributes of a first message in accordance with a first API and attributes of said second message in accordance with a second API, said attributes comprising:
a first attribute code in accordance with said first API and a second attribute code in accordance with said second API, each of said first and second attribute codes being specific to a vendor and an application of said vendor;
a first attribute length in accordance with said first API and a second attribute length in accordance with said second API; and
a first attribute type in accordance with said first API and a second attribute type in accordance with said second API;
wherein each of said first attribute code, first attribute length, and first attribute type are converted into said second attribute code, said second attribute length, and said second attribute type to effect a conversion of said first message configured in accordance with said first API to said second message configured in accordance with said second API;
wherein said translation and routing module is operatively connected to a first application interface module and is configured to receive said first message configured in accordance with said first API; and
further wherein said translation and routing module is operatively connected to a second application interface module and is configured to route said second message to said second application interface module to effect communication from said first application to said second application.

19. The API translation agent of claim 18, wherein said first application comprises a software application and said second application comprises a network access control agent, and further wherein said first application, said second application, and said API translation agent reside on an end point computing device.

20. The API translation agent of claim 18, wherein said first application comprises a network access control agent and said second application comprises a software application, and further wherein said first application, said second application, and said API translation agent reside on an end point computing device.

21. An application programming interface (API) translation agent for a network access control (NAC) system on an end point computing device, comprising:
a first NAC interface emulator component comprising at least one interface emulator module, said interface emulator module being configured to emulate a first API associated with a first NAC agent, said interface emulator module being further configured to receive a first message from a first application on said end point computing device, said message being configured in accordance with said first API;
an NAC protocol translation and routing component operatively connected to said first NAC interface emulator component, said translation and routing component comprising an NAC protocol translation and routing module operatively connected to at least one translation table, said translation table including instructions for converting said first message configured in accordance with said first API into a second message configured in accordance with a second API, said second API being associated with a second NAC agent, said second NAC agent being used to determine a status of said first application on said end point computing device;
said NAC protocol translation and routing module being configured to register said first application for communication with said second NAC agent in accordance with said second application;
said NAC protocol translation and routing module being further configured to receive said first message from said first NAC interface emulator component and convert said first message into said second message in accordance with said instructions in said translation table; and
an NAC inspection interface component operatively connected to said NAC protocol translation and routing component, said NAC inspection interface component being configured to receive said second message from said NAC protocol translation and routing component and being further configured to send said second message to said second NAC agent to effect communication between said first application and said second NAC agent.

22. The API translation agent of claim 21, wherein said first message provides information regarding a security posture of said end point computing device and said information is evaluated in determining whether said end point computing device is in compliance with a security policy of a network.

23. The API translation agent of claim 22, wherein said first application comprises a firewall application and said first message includes information regarding a status of a firewall residing on said end point computing device.

24. The API translation agent of claim 22, wherein said first application comprises an antivirus application and said first message includes information regarding a status of said antivirus application.

25. The API translation agent of claim 21, wherein said first application comprises an application required by a policy of a computer network to be present on said end point computing device, said policy of said computer network further requiring a predetermined state of said first application, and said first message includes information used in determining a compliance of said end point computing device with said policy.

26. The API translation agent of claim 21, wherein said NAC interface component, said NAC protocol translation and routing component, and said NAC inspection interface component are initialized upon start-up of said end point computing device.

27. The API translation agent of claim 21, wherein said first message from said first application is in response to a first inquiry from said NAC agent, said first inquiry from said NAC agent being configured in accordance with said second API;
wherein said NAC translation and routing module converts said first inquiry into a corresponding second inquiry configured in accordance with said first API such that said NAC agent can obtain information from said first application.

28. The API translation agent of claim 21, wherein said information from said first application includes information regarding a security status of said end point computing device.

29. The API translation agent of claim 28, wherein said first application comprises a firewall application and said information from said first application comprises a status of a firewall residing on said end point computing device.

30. The API translation agent of claim 28, wherein said application includes an antivirus application and said information from said application includes information regarding a status of said antivirus application.
